(19) United States
(12) Patent Application Publication
(10) Pub. No.: US 2026/0318389 A1
(43) Pub. Date: Oct. 15, 2026

(54) TORQUE TRANSMISSION MECHANISM

(71) Applicant: SEIKO EPSON CORPORATION, Tokyo (JP)

(72) Inventor: Keitaro HASHIZUME, SHIOJIRI-SHI (JP)

(73) Assignee: SEIKO EPSON CORPORATION, Tokyo (JP)

(21) Appl. No.: 19/646,588

(22) Filed: Apr. 14, 2026

(30) Foreign Application Priority Data
Apr. 15, 2025 (JP) 2025-066647

(51) Int. Cl. F16H 25/06

(52) U.S. Cl. CPC F16H 25/06; F16H 2025/063

(57) ABSTRACT

A torque transmission mechanism includes a first member having a cylindrical shape and configured to be rotatable around a rotation axis, the first member having an outer peripheral surface provided with a first groove extending around the rotation axis, a second member having an annular shape surrounding the first member and configured to be rotatable around the rotation axis, the second member having an inner peripheral surface provided with a second groove extending around the rotation axis, one or more first rolling members disposed in the first groove and the second groove and configured to roll in the first groove and the second groove, and a first restriction member disposed between the first member and the second member, configured to allow movement of the first rolling members along the rotation axis, and configured to restrict movement of the first rolling members around the rotation axis.

The present application is based on, and claims priority from JP Application Serial Number 2025-066647, filed Apr. 15, 2025, the disclosure of which is hereby incorporated by reference herein in its entirety.

### BACKGROUND

### 1. Technical Field

The present disclosure relates to a torque transmission mechanism.

### 2. Related Art

With regard to a torque transmission mechanism, JP-A-2019-132364 discloses an eccentric oscillating type deceleration mechanism. In the deceleration mechanism of JP-A-2019-132364, torque transmission is realized by transmitting a rotation component of an external gear to a carrier body via an inner pin.

In the technique of JP-A-2019-132364, there is a possibility that the inner pin is broken due to a load in a shearing direction generated in the inner pin that transmits torque during operation of the mechanism.

### SUMMARY

According to one aspect of the present disclosure, a torque transmission mechanism is provided.

The torque transmission mechanism includes a first member that has a cylindrical shape and that is configured to be rotatable around a rotation axis, the first member having an outer peripheral surface provided with a first groove extending around the rotation axis; a second member that has an annular shape surrounding the first member and that is configured to be rotatable around the rotation axis, the second member having an inner peripheral surface provided with a second groove extending around the rotation axis; one or more first rolling members that are disposed in the first groove and the second groove and that are configured to roll in the first groove and the second groove; and a first restriction member that is disposed between the first member and the second member, that is configured to allow movement of the first rolling members along the rotation axis, and that is configured to restrict movement of the first rolling members around the rotation axis.

The first groove and the second groove are formed in a periodic wave shape having one or more crest portions and trough portions around the rotation axis.

The first groove includes a first curved portion having a curved shape in at least a part of the first groove. the second groove includes a second curved portion having a curved shape in at least a part of the second groove.

### BRIEF DESCRIPTION OF THE DRAWINGS

FIG. 1 is a perspective view illustrating a schematic configuration of a torque transmission mechanism in a first embodiment.

FIG. 2 is an exploded perspective view illustrating a schematic configuration of the torque transmission mechanism in the first embodiment.

FIG. 3 is a cross-sectional view taken along line III-III of FIG. 1.

FIG. 4 is a cross-sectional view taken along line IV-IV in FIG. 1.

FIG. 5 is a first explanatory diagram of the torque transmission mechanism in the first embodiment.

FIG. 6 is a second explanatory diagram of the torque transmission mechanism in the first embodiment.

FIG. 7 is an explanatory diagram of a groove in an other embodiment.

FIG. 8 is an explanatory diagram of a first groove and a second groove in a second embodiment.

FIG. 9 is a cross-sectional view schematically illustrating a schematic configuration of a torque transmission mechanism in a third embodiment.

FIG. 10 is a cross-sectional view taken along line X-X in FIG. 9.

FIG. 11 is a cross-sectional view schematically illustrating a schematic configuration of a torque transmission mechanism in a fourth embodiment.

FIG. 12 is a cross-sectional view schematically illustrating a schematic configuration of a torque transmission mechanism in a fifth embodiment.

FIG. 13 is a perspective view illustrating a schematic configuration of a torque transmission mechanism in a sixth embodiment.

FIG. 14 is an exploded perspective view illustrating a schematic configuration of the torque transmission mechanism in the sixth embodiment.

FIG. 15 is a cross-sectional view taken along line XV-XV in FIG. 13.

FIG. 16 is a cross-sectional view taken along line XVI-XVI in FIG. 13.

FIG. 17 is an explanatory diagram of a first example of a torque transmission mechanism according to the other embodiment.

FIG. 18 is an explanatory diagram of a second example of a torque transmission mechanism in the other embodiment.

FIG. 19 is an explanatory diagram of a third example of a torque transmission mechanism in the other embodiment.

### DESCRIPTION OF EMBODIMENTS

### A. FIRST EMBODIMENT

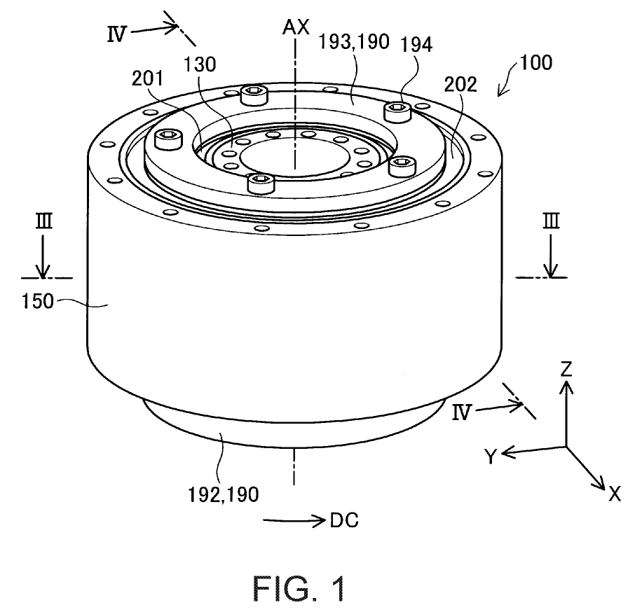

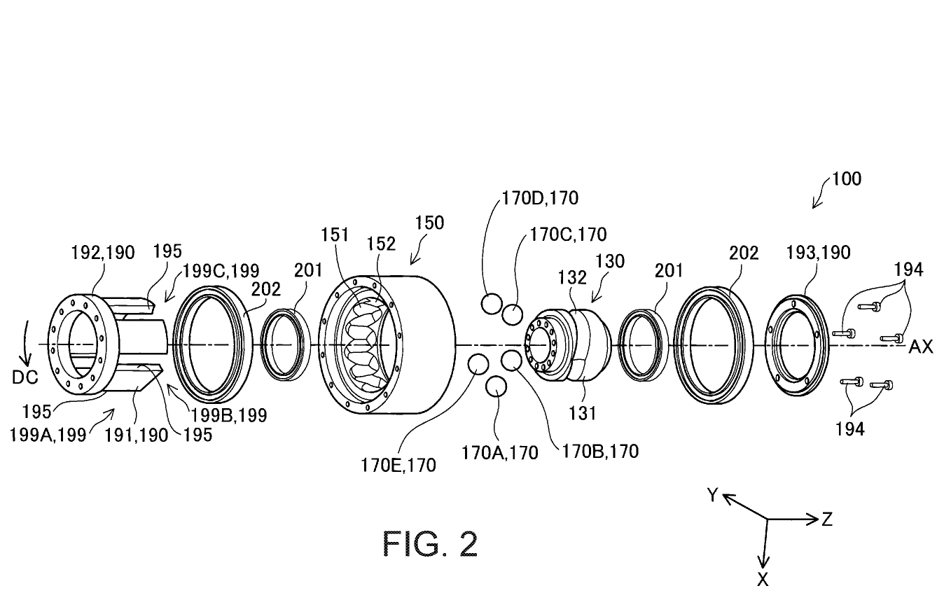

FIG. 1 is a perspective view illustrating a schematic configuration of a torque transmission mechanism 100 in a first embodiment. FIG. 2 is an exploded perspective view illustrating a schematic configuration of the torque transmission mechanism 100. In FIG. 1, arrows indicating X, Y, and Z directions orthogonal to each other are illustrated. The X direction and the Y direction are directions parallel to a horizontal plane, and the Z direction is a direction along a vertically upward direction. The arrows indicating the X, Y, and Z directions are appropriately illustrated in other drawings so that the illustrated directions correspond to those in FIG. 1. In the following description, when a direction is specified, a direction indicated by an arrow in each drawing is referred to as "+" and an opposite direction is referred to as "-", and positive and negative signs are used in combination for direction notation. Hereinafter, a +Z direction is also referred to as "upper", and a -Z direction is also referred to as "lower".

In the present embodiment, the torque transmission mechanism 100 is configured as a deceleration device. As illustrated in FIG. 1 and FIG. 2, the torque transmission mechanism 100 is provided with a first member 130, a second member 150, one or more first rolling members 170, and a first restriction member 190. The torque transmission mechanism 100 according to the present embodiment further includes a first bearing section 201 and a second bearing section 202.

The torque transmission mechanism 100 in the present embodiment has a cylindrical shape as a whole. The torque transmission mechanism 100 is disposed such that a rotation axis AX of the torque transmission mechanism 100 is along the Z direction. In the present embodiment, the rotation axis AX corresponds to the rotation axis of the first member 130 and the rotation axis of the second member 150. Note that in the present disclosure, "cylindrical shape" includes a solid cylindrical shape and a hollow cylindrical shape. Hereinafter, a direction along the rotation axis AX is also referred to as a rotation axis AX direction.

A circumferential direction DC of the torque transmission mechanism 100 corresponds to a circumferential direction of the first member 130 and a circumferential direction of the second member 150. In the present disclosure, the circumferential direction DC is defined as a counterclockwise direction when the torque transmission mechanism 100 is viewed from the +Z direction side. In the following description, unless otherwise specified, "counterclockwise" means counterclockwise when the torque transmission mechanism 100 is viewed from the +Z direction side. The same applies to the "clockwise" direction.

The first member 130 has a cylindrical shape. More specifically, the first member 130 has a hollow cylindrical shape. The first member 130 is disposed such that an axial direction of the first member 130 is along the Z direction. In the present embodiment, the first member 130 is disposed at the innermost side in the horizontal direction among the components of the torque transmission mechanism 100. The first member 130 is configured to be rotatable around the rotation axis AX of the torque transmission mechanism 100. As illustrated in FIG. 2, the first member 130 has an outer peripheral surface 131. The outer peripheral surface 131 is provided with a first groove 132. The first groove 132 has a wave shape extending around the rotation axis AX on the outer peripheral surface 131. In the present specification, "wave shape" means a shape extending so as to go in a direction orthogonal to a certain direction while reciprocating one or more times in the certain direction. That is, the wave shape has one or more turn-back points. The turn-back point of the wave shape may be sharp or rounded. The first groove 132 will be described in detail later.

As illustrated in FIG. 1 and FIG. 2, the second member 150 has an annular shape surrounding the first member 130. That is, the inner diameter of the second member 150 is larger than the outer diameter of the first member 130. The second member 150 is disposed such that an axial direction of the second member 150 is along the Z direction. In the present embodiment, the second member 150 is disposed on the outermost side in the horizontal direction among the components of the torque transmission mechanism 100. The second member 150 is configured to be rotatable around the rotation axis AX. As illustrated in FIG. 2, the second member 150 has an inner peripheral surface 151. The inner peripheral surface 151 is provided with a second groove 152. The second groove 152 has a wave shape extending around the rotation axis AX on the inner peripheral surface 151. The second groove 152 will be described in detail later.

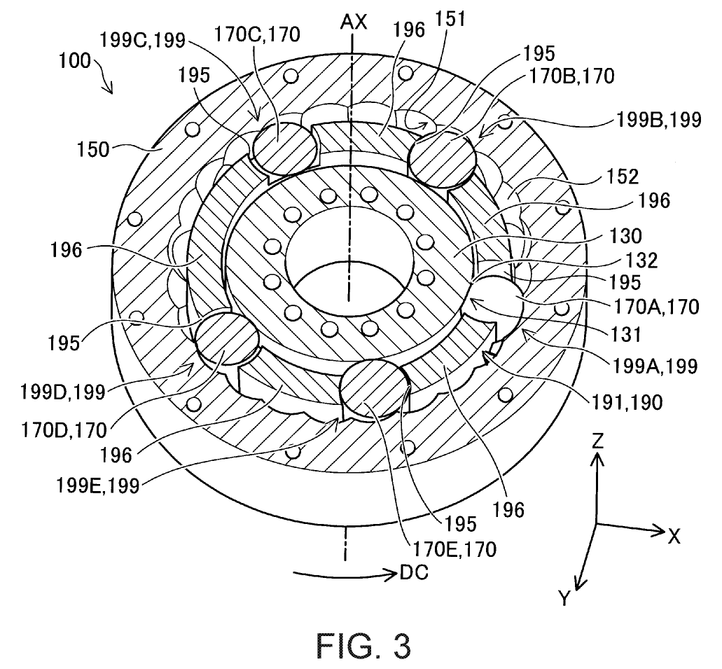

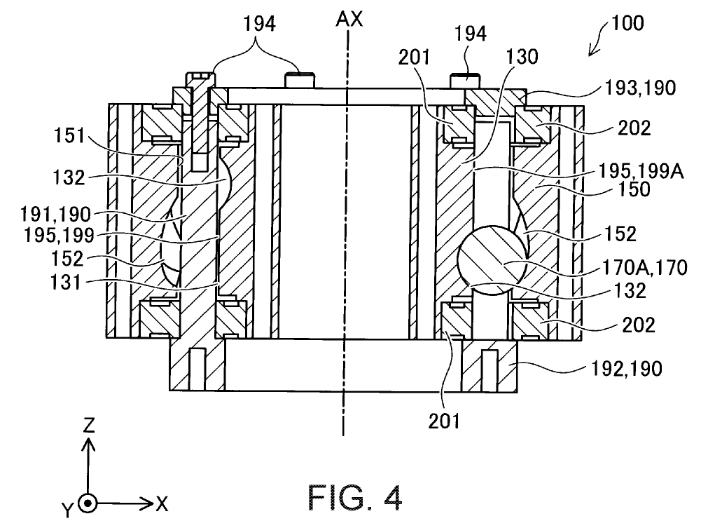

FIG. 3 is a cross-sectional view taken along line III-III in FIG. 1. FIG. 4 is a cross-sectional view taken along line IV-IV in FIG. 1. As illustrated in FIG. 3 and FIG. 4, the first rolling members 170 are disposed in the first groove 132 and the second groove 152 between the first member 130 and the second member 150. The first rolling members 170 are configured to roll in the first groove 132 and the second groove 152. Specifically, as viewed along a radial direction of the torque transmission mechanism 100, the first rolling members 170 roll in the first groove 132 and the second groove 152 so as to be disposed at a position where the first groove 132 and the second groove 152 intersect each other. The first rolling members 170 roll in the first groove 132, thereby the first rolling members 170 and the first member 130 move relative to each other. The first rolling members 170 roll in the second groove 152, thereby the first rolling members 170 and the second member 150 move relative to each other. The first rolling members 170 in the present embodiment have a spherical shape. The first rolling members 170 are configured as, for example, a so-called steel ball, and are made of stainless steel, iron steel, or the like. As described below, the first rolling members 170 transmit torque between the first member 130 and the second member 150.

In the present embodiment, the first rolling members 170 include a rolling member 170A, a rolling member 170B, a rolling member 170C, a rolling member 170D, and a rolling member 170E. When the rolling members 170A to 170E are not distinguished from each other, each rolling member is also simply referred to as the first rolling member 170. The rolling members 170A, 170B, 170C, 170D, and 170E are disposed in this order in the circumferential direction DC when the torque transmission mechanism 100 is viewed from the +Z direction side.

As illustrated in FIG. 3 and FIG. 4, the first restriction member 190 is disposed between the first member 130 and the second member 150. In the present embodiment, the first restriction member 190 has a hollow cylindrical shape as a whole. The first restriction member 190 is disposed such that an axial direction of the first restriction member 190 is along the Z direction.

The first restriction member 190 has a main body section 191, a first flange section 192, and a second flange section 193. The main body section 191 is a portion of the first restriction member 190 that is disposed inside the annular ring of the second member 150. The first flange section 192 is an annular flange section constituting a lower end section of the first restriction member 190. The second flange section 193 is an annular flange section constituting an upper end section of the first restriction member 190. As illustrated in FIG. 1 and FIG. 4, the first flange section 192 is not disposed inside the annular ring of the second member 150, but is disposed below the lower end section of the first member 130 and the lower end section of the second member 150. Substantially similarly, the second flange section 193 is disposed above the upper end section of the first member 130 and the upper end section of the second member 150. In the present embodiment, the first flange section 192 is formed integrally with the main body section 191. The second flange section 193 is configured as a cap separate from the main body section 191, and is fixed to the main body section 191 via bolts 194. The outer diameter of the main body section 191 is smaller than the inner diameter of the second member 150. On the other hand, the outer diameters of the first flange section 192 and the second flange section 193 are larger than the inner diameter of the second member 150. The inner diameter of the main body section 191 is larger than the outer diameter of the first member 130. On the other hand, the inner diameters of the first flange section 192 and the second flange section 193 are smaller than the outer diameter of the first member 130. The inner diameter of the first flange section 192 is substantially the same as the inner diameter of the second flange section 193. The outer diameter of the first flange section 192 is substantially the same as the outer diameter of the second flange section 193.

As illustrated in FIGS. 2 to 4 , the main body section 191 has slit sections 195. In the present embodiment, the main body section 191 has five slit sections 195. Each slit section 195 is configured as an opening section extending along the rotation axis AX, that is, along the Z direction. Wall sections 196 of the main body section 191 are disposed between the opening sections of the slit sections 195. The wall section 196 corresponds to a wall in the circumferential direction DC among walls that define the opening section of the slit section 195. As illustrated in FIGS. 2 and 4 , in the present embodiment, the lower end of the opening section of the slit section 195 is defined by the first flange section 192. As illustrated in FIG. 4, the upper end of the opening section of the slit section 195 is defined by the second flange section 193. The opening width of the opening of the slit section 195 in the circumferential direction DC is slightly larger than the diameter of the first rolling member 170. The opening length of the slit section 195 in the Z direction is larger than the opening width of the slit section 195.

The first restriction member 190 has a first restriction section 199. The first restriction section 199 allows the first rolling member CP2 to move along the rotation axis AX, that is, to move in the Z direction. On the other hand, the first restriction section 199 restricts the movement of the first rolling member 170 around the rotation axis AX. In the present embodiment, the first restriction section 199 includes a restriction section 199A, a restriction section 199B, a restriction section 199C, a restriction section 199D, and a restriction section 199E. Hereinafter, when the restriction sections 199A to 199E are not distinguished from each other, each of them is also simply referred to as the first restriction section 199. The first restriction section 199 is also simply referred to as a restriction section.

Specifically, in the present embodiment, the first restriction section 199 has the slit section 195 described above, and the slit section 195 realizes the allowance and restriction of the movement of the first rolling member 170. For example, the rolling member 170A is disposed in the slit section 195 of the restriction section 199A. As a result, the rolling member 170A is allowed to move in the Z direction along the slit section 195. On the other hand, the movement of the rolling member 170A around the rotation axis AX is restricted by the wall section 196 that defines the slit section 195. Similarly, the rolling members 170B to 170E are disposed in the slit sections 195 of the restriction sections 199B to 199E, respectively. Note that the number of the first rolling members 170 is desirably determined in consideration of, for example, the strength of the first restriction member 190. Specifically, the greater the number of first rolling members 170, the greater the total opening area of each slit section 195 in first restriction member 190, which may reduce the strength of first restriction member 190. The number of the first rolling members 170 is desirably determined to be small enough to suppress such a decrease in strength.

The first bearing section 201 is disposed between the first member 130 and the first restriction member 190. The first bearing section 201 holds the first member 130 so as to be rotatable around the rotation axis AX with respect to the first restriction member 190. The first bearing section 201 is configured by various bearings such as a ball bearing and a needle bearing. In the present embodiment, two first bearing sections 201 are provided. The first bearing sections 201 are press-fitted and fixed to the outside of the upper end section and the outside of the lower end section of the first member 130, and axially support the upper end section and the lower end section of the first member 130. The first bearing section 201 on the lower end section side of the first member 130 is disposed so as to be in contact with the upper surface of the first flange section 192 inside the main body section 191. The first bearing section 201 on the upper end section side of the first member 130 is disposed so as to be in contact with the lower surface of the second flange section 193 inside the main body section 191. As a result, the first member 130 is held rotatably with respect to the first restriction member 190, while the movement of the first member 130 in the Z direction with respect to the first restriction member 190 is restricted.

The second bearing section 202 is disposed between the second member 150 and the first restriction member 190. The second bearing section 202 holds the second member 150 so as to be rotatable around the rotation axis AX with respect to the first restriction member 190. The second bearing section 202 is configured by, for example, various bearings similarly to the first bearing section 201. In the present embodiment, two second bearing sections 202 are provided. The second bearing sections 202 are press-fitted and fixed to the inside of the upper end section and the inside of the lower end section of the second member 150, and axially support the upper end section and the lower end section of the second member 150. The second bearing section 202 on the lower end section side of the second member 150 is disposed so as to be in contact with the upper surface of the first flange section 192 outside of the main body section 191. The second bearing section 202 on the upper end section side of the second member 150 is disposed so as to be in contact with the lower surface of the second flange section 193 outside the main body section 191. As a result, the second member 150 is held rotatably with respect to the first restriction member 190, while the movement of the second member 150 in the Z direction with respect to the first restriction member 190 is restricted.

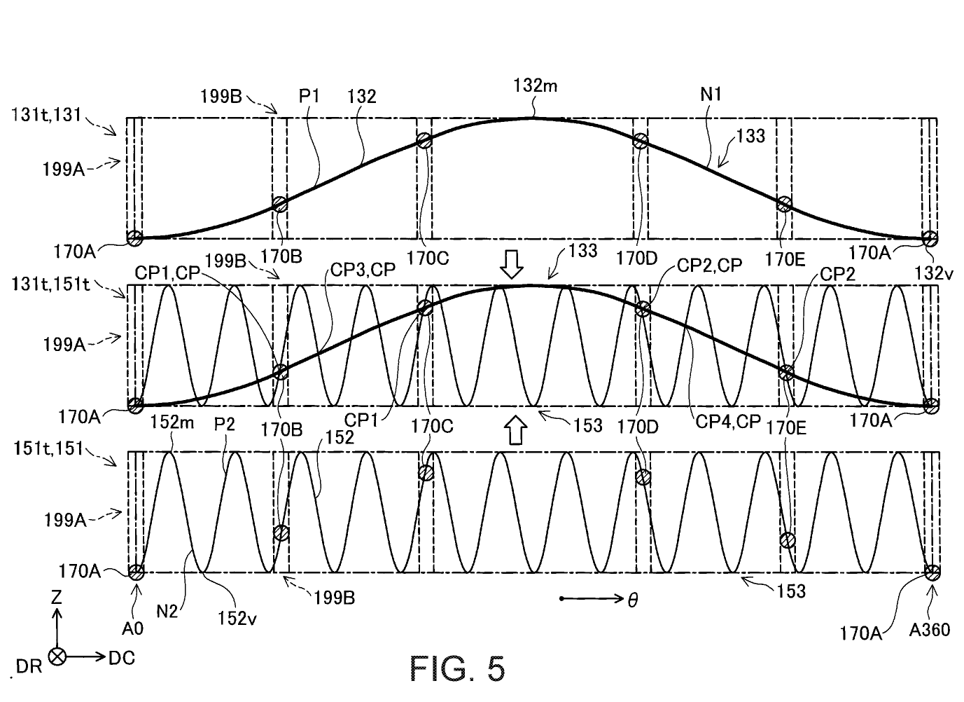

FIG. 5 is a first explanatory diagram of the torque transmission mechanism 100. FIG. 5 illustrates an outer peripheral surface 131t and an inner peripheral surface 151t. The outer peripheral surface 131t corresponds to the developed outer peripheral surface 131. The inner peripheral surface 151t corresponds to the developed inner peripheral surface 151. FIG. 5 illustrates a state in which the outer peripheral surface 131t and the inner peripheral surface 151t are overlapped. In FIG. 5, the first restriction sections 199 are schematically indicated by a broken line. In FIG. 5, the first rolling members 170 are schematically indicated by hatching.

FIG. 5 illustrates an angle θ at the outer peripheral surface 131 and the inner peripheral surface 151. The angle θ corresponds to a rotation angle around the rotation axis AX, and increases as it goes in the circumferential direction DC. The angular position A0 of 0° and the angular position A360 of 360° illustrated in FIG. 5 are the same position. In the present embodiment, the restriction section 199A is positioned at the angular position A0. In FIG. 5, to facilitate understanding of the technology, the rolling member 170A and the restriction section 199A are illustrated near the angular position A0 and near the angular position A360, respectively. However, in practice, the number of rolling members 170A and the number of restriction sections 199A are one.

In FIG. 5, the first groove 132 is indicated by a thick line. The first groove 132 has a closed ring shape that makes a full circle around the outer peripheral surface 131 along the circumferential direction DC. The first groove 132 has a periodic wave shape that as a whole advance along the circumferential direction DC while reciprocating in the Z direction on the outer peripheral surface 131. That is, when the first groove 132 is regarded as a wave, the propagation direction of the first groove 132 is a direction along the circumferential direction DC, and the vibration direction of the first groove 132 is the Z direction. Hereinafter, the direction along the trajectory of the first groove 132 is also referred to as a first groove direction.

The first groove 132 includes a first curved portion 133 having a curved shape in at least a portion of the first groove 132 in the first groove direction. In the present embodiment, the curved shape of the first curved portion 133 is a shape according to a sine curve. Therefore, at least a portion of the first curved portion 133 represents a sine curve. More specifically, in the present embodiment, the entire first groove 132 has a shape representing a sine curve. As a result, in the present embodiment, the entire first groove 132 corresponds to the first curved portion 133. In the present embodiment, the first curved portion 133 includes at least one of a crest portion 132m and a trough portion 132v of the first groove 132. More specifically, the first curved portion 133 includes all the crest portions 132m and all the trough portions 132v.

In the present embodiment, the first groove 132 has one period. That is, the first groove 132 has one crest portion 132m and one trough portion 132v. The crest portion 132m and the trough portion 132v correspond to the crest and the trough of a sine curve, respectively, and have a rounded shape according to a sine curve. The positions of the crest portions 132m in the Z direction are substantially the same. The positions of the trough portions 132v in the Z direction are substantially the same. That is, when the first groove 132 is regarded as a wave, the amplitude of the first groove 132 is substantially constant. Each of the crest portions and the trough portions corresponds to a turn-back point of the above described wave shape. Note that in the present embodiment, the crest portion is positioned on the +Z direction side of the trough portion. In another embodiment, the positional relationship between the crest portion and the trough portion may be reversed.

The second groove 152 has a closed ring shape that makes a full circle around the inner peripheral surface 151 along the circumferential direction DC. The second groove 152 has a periodic wave shape that advances along the circumferential direction DC while reciprocating in the Z direction on the inner peripheral surface 151 as a whole. That is, when the second groove 152 is regarded as a wave, the propagation direction of the second groove 152 is a direction along the circumferential direction DC, and the vibration direction of the second groove 152 is the Z direction. Hereinafter, the direction along the trajectory of the second groove 152 is also referred to as a second groove direction.

The second groove 152 includes a second curved portion 153 having a curved shape in at least a portion of the second groove 152 in the second groove direction. In the present embodiment, the curved shape of the second curved portion 153 has a shape according to a sine curve. Therefore, at least a part of the second curved portion 153 represents a sine curve. More specifically, in the present embodiment, the entire second groove 152 has a shape representing a sine curve. As a result, in the present embodiment, the entire second groove 152 corresponds to the second curved portion 153. In the present embodiment, the second curved portion 153 includes at least one of a crest portion 152m and a trough portion 152v of the second groove 152. More specifically, the second curved portion 153 includes all the crest portions 152m and all the trough portions 152v.

In the present embodiment, the second groove 152 has a different period from the first groove 132. Specifically, the second groove 152 has twelve periods. That is, the second groove 152 has twelve crest portions 152m and twelve trough portions 152v. The crest portion 152m and the trough portion 152v correspond to the crest and the trough of a sine curve, respectively, and have a rounded shape according to a sine curve. The positions of the crest portions 152m in the Z direction are substantially the same, and are substantially the same as the positions of the crest portions 132m in the Z direction. The positions of the trough portions 152v in the Z direction are substantially the same, and are substantially the same as the positions of the trough portions 132v in the Z direction. That is, when second groove 152 is regarded as a wave, the amplitude of second groove 152 is substantially constant and substantially the same as the amplitude of first groove 132.

In the torque transmission mechanism 100 of the present embodiment, one of the first member 130 and the second member 150 is used as an input shaft, and another is used as an output shaft. Hereinafter, the operation of the torque transmission mechanism 100 in the case where the first member 130 is used as an input shaft will be described.

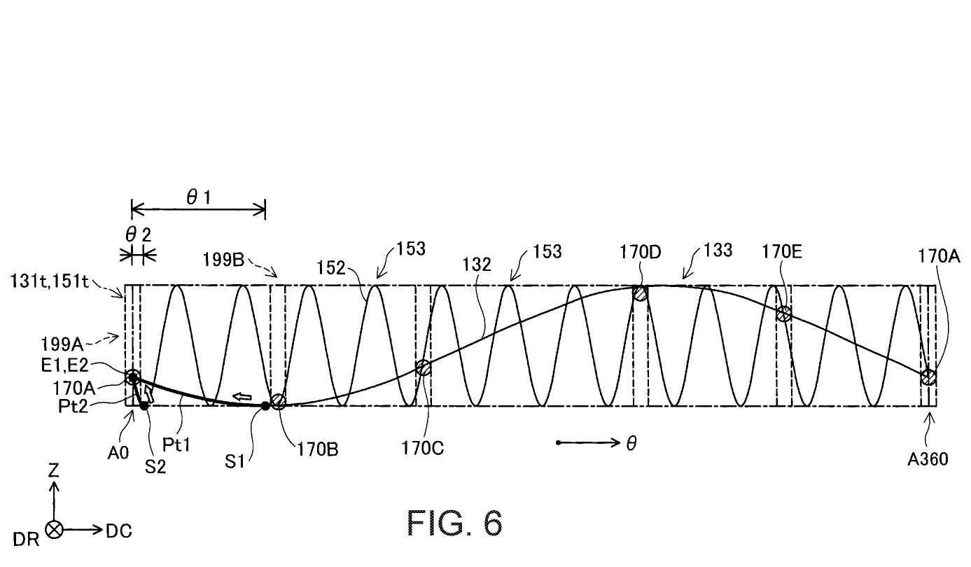

FIG. 6 is a second explanatory diagram of the torque transmission mechanism 100. FIG. 6 illustrates a state in which the first member 130 as an input shaft has rotated in the circumferential direction DC around the rotation axis AX by a rotation angle θ1 from the state illustrated in FIG. 5. In the example of FIG. 6, the rotation angle θ1 is 60°.

As illustrated in FIG. 6, the first member 130 rotates around the rotation axis AX, thereby each first rolling member 170 rolls in the first groove 132 and the second groove 152. Specifically, by rotation of the first member 130, the first rolling member 170 rolls in a path Pt1 in the first groove 132. The path Pt1 is a path in which the length of the path Pt1 in the circumferential direction DC corresponds to the rotation angle θ1. Specifically, the path Pt1 is a path in which, among the first groove 132, the position of the first rolling member 170 before the start of rotation of the first member 130 is a start point S1, and a position advanced from the start point in the circumferential direction DC by an amount corresponding to the rotation angle θ1 is an end point E1. In FIG. 6, as an example of the path Pt1, the path Pt1 for the rolling member 170A is indicated by a thick line. When the first rolling member 170 rolls in the path Pt1, the movement of the first rolling member 170 around the rotation axis AX is restricted, thereby the first rolling member 170 moves only in the Z direction along the first groove 132. As a result, the position of the first rolling member 170 in the circumferential direction DC does not change, whereas the position of the first rolling member 170 in the Z direction changes in accordance with the position of the path Pt1 in the Z direction. The first rolling member 170 rolls on a path Pt2 in the second groove 152 while moving in the Z direction in this manner, thereby transmitting torque to the second member 150 via the second groove 152 and rotating the second member 150 around the rotation axis AX. The path Pt2 is a path in which a change in the position of the first rolling member 170 in the rotation axis AX direction when passing through the path Pt2 is the same as a change in the position of the first rolling member 170 in the rotation axis AX direction when passing through the path Pt1. In FIG. 6, as an example of the path Pt2, the path Pt2 for the rolling member 170A is indicated by a thick line. As a result, the second member 150 rotates around the rotation axis AX by a rotation angle θ2 corresponding to the length of the path Pt2 in the circumferential direction DC, that is, the length between the start point S2 and the end point E2 of the path Pt2 in the circumferential direction DC. The ratio of the rotation angle θ2 to the rotation angle θ1 corresponds to the ratio of a period T2 of the first groove 132 to a period T1 of the second groove 152. That is, a deceleration ratio RR1a in this case corresponds to a value obtained by dividing the period T1 by the period T2. Note that as indicated by white arrows in FIG. 6, it can be said that the first rolling member 170 such as the rolling member 170A moves in the first groove 132 and the second groove 152 in a direction opposite to the rotation direction of the first member 130 and the second member 150 relative to the first member 130 and the second member 150.

The operation of the torque transmission mechanism 100 when the second member 150 is used as an input shaft is substantially the same as the operation of the torque transmission mechanism 100 when the first member 130 is used as an input shaft. In this case, the first rolling member 170 rolls in the first groove 132 by the rotation of the second member 150, thereby transmitting the torque to the first member 130 via the first groove 132. A deceleration ratio RR1b in this case corresponds to a value obtained by dividing the period T2 by the period T1. That is, in this case, the rotation input to the torque transmission mechanism 100 via the second member 150 is accelerated via the first member 130 and output.

As illustrated in FIG. 5, each first rolling member 170 is disposed at intersection positions CP where the first groove 132 and the second groove 152 intersect with each other as viewed along a radial direction DR. The intersection positions CP include a first intersection position CP1, a second intersection position CP2, a third intersection position CP3, and a fourth intersection position CP4. The first intersection position CP1 is a position where a first positive portion P1 and a second positive portion P2 intersect each other. The first positive portion P1 is a portion among the first groove 132 extending from the trough portion 132v toward the crest portion 132m in a forward direction of the circumferential direction DC. The second positive portion P2 is a portion among the second groove 152 extending from the trough portion 152v toward the crest portion 152m in the forward direction of the circumferential direction DC. The second intersection position CP2 is a position where a first negative portion N1 and a second negative portion N2 intersect each other. The first negative portion N1 is a portion among the first groove 132 extending from the crest portion 132m toward the trough portion 132v in the forward direction of the circumferential direction DC. The second negative portion N2 is a portion among the second groove 152 extending from the crest portion 152m toward the trough portion 152v in the forward direction of the circumferential direction DC. The third intersection position CP3 is a position where the first positive portion P1 and the second negative portion N2 intersect each other. The fourth intersection position CP4 is a position where the first negative portion N1 and the second positive portion P2 intersect each other. Note that the first positive portion P1 and the first negative portion N1 both include the apex of the crest portion 132m and the apex of the trough portion 132v. The second positive portion P2 and the second negative portion N2 both include the apex of the crest portion 152m and the apex of the trough portion 152v.

In the present embodiment, each first rolling member 170 is disposed at the first intersection position CP1 or the second intersection position CP2. As a result, the rotation directions of the first member 130 and the second member 150 coincide with each other. Note that in another embodiment, the first rolling members 170 may be disposed at the third intersection position CP3 and the fourth intersection position CP4. In this case, the rotation direction of the first member 130 and the rotation direction of the second member 150 are opposite to each other.

According to the torque transmission mechanism 100 of the present embodiment described above, the first rolling member 170 disposed in the first groove 132 of the first member 130 and the second groove 152 of the second member 150 are configured to roll in the first groove 132 and the second groove 152. In the first groove 132 and the second groove 152, the movement of the first rolling member 170 along the rotation axis AX is allowed, and the movement of the first rolling member 170 around the rotation axis AX is restricted. Therefore, torque can be transmitted between the first member 130 and the second member 150 without using a pin for torque transmission. The first groove 132 has the first curved portion 133, and the second groove 152 has the second curved portion 153, thereby the first rolling member 170 can be more smoothly rolled in the first groove 132 and the second groove 152. As a result, it is possible to suppress damage to the first groove 132 and the second groove 152 due to the rolling of the first rolling member 170. Energy loss in the rolling of the first rolling member 170 can be suppressed, and torque can be more efficiently transmitted via the first rolling member 170.

In the present embodiment, at least a part of the first curved portion 133 is provided in at least one of the crest portion 132m and the trough portion 132v of the first groove 132. Therefore, the first rolling member 170 can be more smoothly changed in direction at the crest portion 132m and the trough portion 132v corresponding to the turn-back points in the first groove 132.

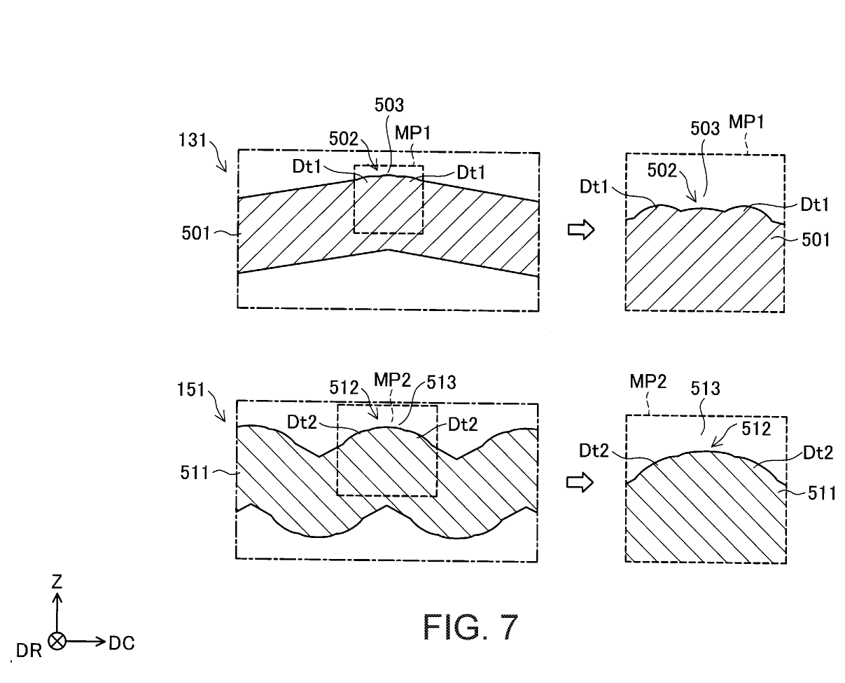

Here, FIG. 7 is an explanatory diagram of grooves 501 and 511 in another embodiment. A part of the outer peripheral surface 131 is illustrated in the upper part of FIG. 7. The upper part of FIG. 7 illustrates an enlarged view of a first portion MP1 of the outer peripheral surface 131. A part of the inner peripheral surface 151 is illustrated in the lower part of FIG. 7. The lower part of FIG. 7 illustrates an enlarged view a second portion MP2 of the inner peripheral surface 151. In FIG. 7, the grooves 501 and 511 are each hatched.

Similarly to the first groove 132, the groove 501 has a closed ring shape that makes a full circle around the outer peripheral surface 131 along the circumferential direction DC, and has a periodic wave shape that advances along the circumferential direction DC while reciprocating in the Z direction on the outer peripheral surface 131 as a whole. Similarly to the second groove 152, the groove 511 has a closed ring shape that makes a full circle around the inner peripheral surface 151 along the circumferential direction DC, and has a periodic wave shape that advances along the circumferential direction DC while reciprocating in the Z direction on the inner peripheral surface 151 as a whole. However, unlike the first groove 132, the groove 501 does not have the first curved portion 133. Unlike the second groove 152, the groove 511 does not have the second curved portion 153. More specifically, the grooves 501 and 511 have a triangular wave shape corresponding to a triangular wave as a whole. As a result, the turn-back section 502 of the groove 501 and the turn-back section 512 of the groove 511 have a pointed shape corresponding to the apex of a triangle, rather than a rounded shape. The turn-back sections 502 and 512 referred to herein correspond to a crest portion or a trough portion. The first portion MP1 described above is a portion including the turn-back section 502. The second portion MP2 is a portion including the turn-back section 512.

For example, when the first rolling member 170 rolling in the groove 501 having the sharply pointed turn-back section 502 passes through the turn-back section 502, that is, when the direction is changed to the Z direction along the rotation axis AX direction at the turn-back section 502, it is likely to enter the turn-back section 502 while the moving direction and the moving speed before the turn-back section 502 are maintained. As a result, the first rolling member 170 cannot smoothly pass through the turn-back section 502, and is highly likely to collide with the outer wall section 503 positioned outside the turn-back section 502. Such collision between the first rolling member 170 and the outer wall section 503 causes damage to the groove 501 and loss of kinetic energy of the first rolling member 170. FIG. 7 illustrates a recess Dt1 generated in the outer wall section 503 as an example of such damage of the groove 501. In contrast, in the present embodiment, at least a part of the first curved portion 133 is provided on the crest portion 132m or the trough portion 132v, thereby the crest portion 132m or the trough portion 132v is rounded. As a result, the first rolling member 170 rolling in the first groove 132 can be caused to pass through the crest portion 132m and the trough portion 132v more smoothly, and collision between the first rolling member 170 and the outer wall section of the first groove 132 can be effectively suppressed. As a result, damage to the first groove 132 due to the rolling of the first rolling member 170 and energy loss due to the rolling of the first rolling member 170 can be more effectively suppressed.

Regarding the groove 511, similarly to the groove 501 described above, damage to the groove 511, such as a recess Dt2 of the outer wall section 513 positioned outside the turn-back section 512, may occur in the turn-back section 512 of the groove 511. In contrast, in the present embodiment, at least a part of the second curved portion 153 is provided on the crest portion 152m or the trough portion 152v, thereby the crest portion 152m or the trough portion 152v is rounded. As a result, the first rolling member 170 rolling in the second groove 152 can be caused to pass through the crest portion 152m and the trough portion 152v more smoothly, and collision between the first rolling member 170 and the outer wall section of the second groove 152 can be effectively suppressed. As a result, damage to the second groove 152 due to the rolling of the first rolling member 170 and energy loss due to the rolling of the first rolling member 170 can be more effectively suppressed.

In the present embodiment, the curved shape of the first curved portion 133 and the curved shape of the second curved portion 153 include a shape according to a sine curve. Therefore, the first curved portion 133 and the second curved portion 153 are more simply configured, and the first rolling member 170 can be more smoothly rolled in the first groove 132 and the second groove 152.

In the present embodiment, the first groove 132 and the second groove 152 each have an overall shape that represents a sine curve. In this way, the configuration further simplifies the configuration of the first groove 132 and the second groove 152.

In the present embodiment, the number of the crest portions 132m and the number of the trough portions 132v of the first groove 132 are different from the number of the crest portions 152m and the number of the trough portions 152v of the second groove 152. According to this aspect, the rotation speed can be decelerated between the first member 130 and the second member 150 according to the number of the crest portions 132m and the trough portions 132v of the first groove 132 and the number of the crest portions 152m and the trough portions 152v of the second groove 152. That is, the rotation speed can be decelerated between the first member 130 and the second member 150 according to the difference between the period T1 of the first groove 132 and the period T2 of the second groove 152. In the present embodiment, arbitrarily changing the combination of the period T1 and the period T2, thereby various deceleration ratios can be achieved with high flexibility.

In the present embodiment, the first rolling member 170 has a spherical shape. Therefore, the first rolling member 170 can be rolled more smoothly in the first groove 132 and the second groove 152. As a result, it is possible to suppress wear of the first member 130, the second member 150, the first rolling member 170, and the first restriction member 190.

In the present embodiment, the first rolling member 170 includes one rolling member 170A and another rolling member 170B. In this way, torque can be transmitted between the first member 130 and the second member 150 using the rolling member 170A and the rolling member 170B. Therefore, for example, compared to a configuration in which the rolling member 170A is provided, the load of each first rolling member 170 can be reduced.

As in the present embodiment, by providing the plurality of first rolling members 170, it becomes easy to uniquely determine the rotation direction of the second member 150 with respect to the first member 130 or the rotation direction of the first member 130 with respect to the second member 150. Specifically, for example, in the case where only the rolling member 170A is provided, when the rolling member 170A reaches the crest portion 152m or the trough portion 152v of the second groove 152 due to the rotation of the first member 130 as an input shaft, the rolling member 170A may advance in the second groove 152 toward both the one side and the other side in the circumferential direction DC. As a result, the second member 150 can rotate in both the forward direction of the circumferential direction DC and the reverse direction of the circumferential direction DC, and thus there is a possibility that a phenomenon in which the second member 150 reciprocates in a closed space in the circumferential direction DC occurs. Such a phenomenon is likely to occur particularly when the rotation speed of the first member 130 or the second member 150 is low. Note that such a phenomenon may similarly occur when the second member 150 is used as an input shaft. On the other hand, in the case where the rolling member 170B is provided in addition to the rolling member 170A, for example, when the rolling member 170A reaches the crest portion 152m or the trough portion 152v, the rolling member 170B can be positioned at a portion other than the crest portion 152m and the trough portion 152v of the second groove 152. In this case, by uniquely determining the moving direction of the rolling member 170B in the second groove 152, the moving direction of the rolling member 170B in the second groove 152 and the rotation direction of the second member 150 are also uniquely determined.

In the present embodiment, the first member 130 can be more smoothly rotated with respect to the first restriction member 190 via the first bearing section 201 disposed between the first member 130 and the first restriction member 190.

In the present embodiment, the second member 150 can be more smoothly rotated with respect to the first restriction member 190 via the second bearing section 202 disposed between the second member 150 and the first restriction member 190.

### B. SECOND EMBODIMENT

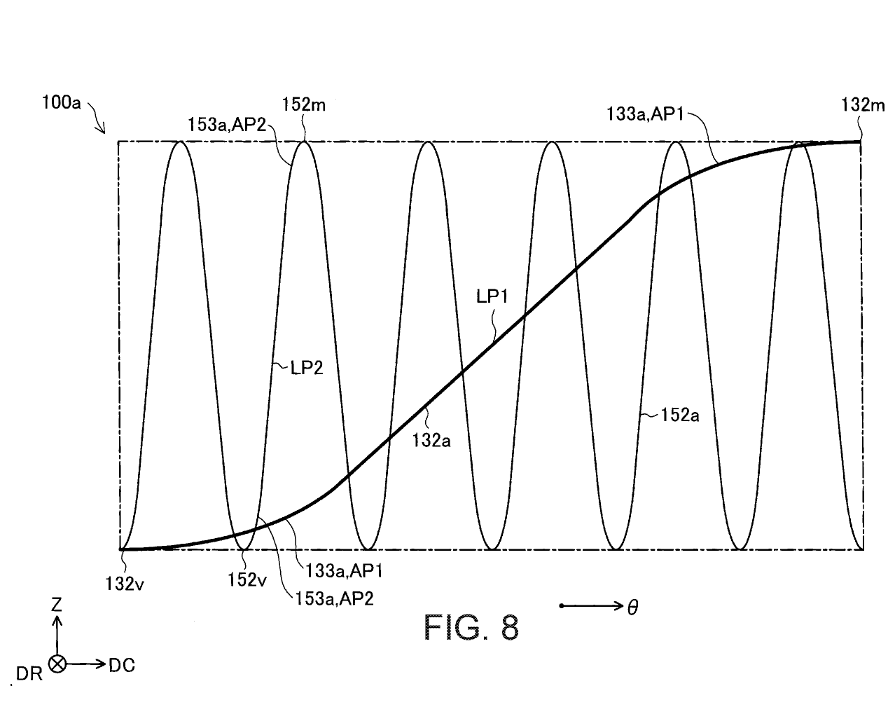

FIG. 8 is an explanatory diagram of a first groove 132a and a second groove 152a in a second embodiment. In FIG. 8, the first rolling member 170, the first restriction section 199, and the like are omitted as appropriate. In the second embodiment, unlike the first embodiment, the entire first groove 132a and an entire second curved portion 153a of the second groove 152a are formed in a Modified Constant Velocity curve (MCV). A torque transmission mechanism 100a of the second embodiment is the same as that of the first embodiment unless otherwise specified.

In the present embodiment, the entire first groove 132a has a shape representing a predetermined curve defined as a type of MCV. The predetermined curve is an MCV including an arc portion and a straight portion that is continuous with the arc portion. The arc portion is an arc shape and is a portion of the predetermined curve that causes generation of positive or negative acceleration. The straight portion is a straight shape is a portion of the predetermined curve that ensures a constant speed. Hereinafter, the arc portion included in the first groove 132a is also referred to as a first arc portion AP1. The straight portion included in the first groove 132a is also referred to as a first straight portion LP1. As a result of the entire first groove 132a being configured as a groove representing a predetermined curve in this manner, the first groove 132a includes a plurality of first curved portions 133a corresponding to each crest portion 132m and each trough portion 132v. Each first curved portion 133a corresponds to the first arc portion AP1. Each first curved portion 133a includes either the crest portion 132m or the trough portion 132v. A portion of the first groove 132a connecting the crest portion 132m and the trough portion 132v corresponds to the first straight portion LP1.

In the present embodiment, the entire second groove 152a also has a shape representing MCV, similarly to the first groove 132a. More specifically, the entire second groove 152a has a shape representing a predetermined curve. Hereinafter, the arc portion included in the second groove 152a is also referred to as a second arc portion AP2. The straight portion included in the second groove 152a is also referred to as a second straight portion LP2. As a result of the entire second groove 152a being configured as a groove representing a predetermined curve in this manner, the second groove 152a includes a plurality of second curved portions 153a corresponding to each crest portion 152m and each trough portion 152v. Each second curved portion 153a corresponds to the second arc portion AP2. Each second curved portion 153a includes either the crest portion 152m or the trough portion 152v. A portion of the second groove 152a connecting the crest portion 152m and the trough portion 152v corresponds to the second straight portion LP2.

According to the torque transmission mechanism 100a of the second embodiment described above, the first groove 132a and the second groove 152a as a whole have a shape representing an MCV. Therefore, the first rolling member 170 can be rolled more smoothly in the first groove 132a and the second groove 152a, and an increase in the maximum speed of the first rolling member 170 can be suppressed. In the present embodiment, since the entire first groove 132a and second groove 152a have a shape representing an MCV, the first groove 132a and the second groove 152a can be more easily manufactured by combining the arc shape and the straight shape.

Note that in another embodiment, the first groove 132 and the second groove 152 are not limited to a sine curve or a modified constant velocity curve, and may be configured as grooves representing various cam curves, for example. “Cam curve" as used herein means a standard curve, or a universal cam curve proposed by Yo Makino et al. Note that the standard curve corresponds to the universal cam curve in which each parameter is set to a specific value. The inventors of the present application have found that the mechanism of operation transmission by the torque transmission mechanism 100 in the present embodiment is similar to the mechanism of operation transmission by the groove cam mechanism. More specifically, in the present embodiment, the first rolling member 170 corresponds to a cam follower common to the first groove 132 and the second groove 152. As a result, the inventors of the present application further found that the cam curve described above can be effectively applied as the shape of the first groove 132 and the second groove 152.

Note that the standard curve includes, in addition to a sine curve and the modified constant velocity curve, a cycloid curve, a modified trapezoid curve, a one-dwell modified trapezoid curve, a modified sine curve, a one-dwell modified sine curve (m=1 or m=2/3), a constant acceleration curve, a trapezoidal velocity curve, an asymmetrical cycloid curve, an asymmetrical modified trapezoid curve, a trapeculoid curve, a one-dwell cycloid curve (m=1 or m=2/3), a one-dwell modified trapezoid fergason, a one-dwell trapeculoid curve, a no-dwell modified trapezoid curve, a no-dwell modified constant velocity curve, a NC2 curve, and the like. The universal cam curve may be configured as a curve obtained by combining any two or more standard curves, for example.

In particular, the first groove 132 and the second groove 152 may each have a shape obtained by combining, for example, two or more of a sine curve, a modified constant velocity curve, a cycloid curve, a modified trapezoid curve, a one-dwell modified trapezoid curve, a modified sine curve, and a one-dwell modified sine curve in the first groove direction. Among these, a cycloid curve, a modified trapezoid curve, and a one-dwell modified trapezoid curve are cam curves desirable for power transmission at a high speed and a light load. A modified sine curve and a one-dwell modified sine curve are cam curves desirable for power transmission at a medium speed and a heavy load. Note that in this case, the first groove 132 and the second groove 152 may include a straight shape, an arc shape, or the like in addition to the above described curves. That is, in this case, the first groove 132 and the second groove 152 may each include two or more of a shape according to a sine curve, a shape according to a modified constant velocity curve, a shape according to a cycloid curve, a shape according to a modified trapezoid curve, a shape according to a one-dwell modified trapezoid curve, a shape according to a modified sine curve, and a shape according to a one-dwell modified sine curve in the first groove direction and the second groove direction. In this way, by applying a cam curve to the first groove 132 and the second groove 152, it is possible to easily realize the torque transmission mechanism 100 having a higher function.

### C. THIRD EMBODIMENT

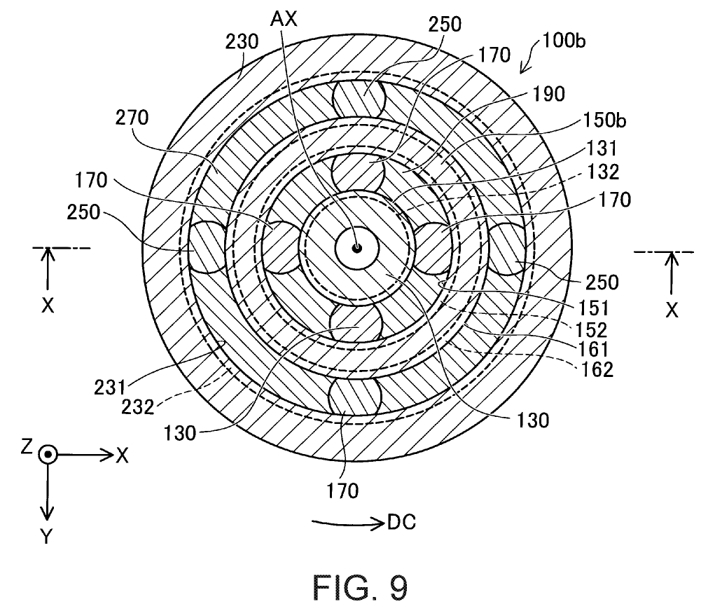

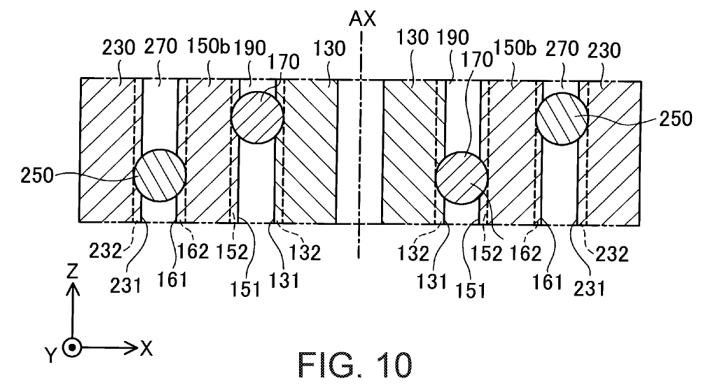

FIG. 9 is a cross-sectional view schematically illustrating a schematic configuration of a torque transmission mechanism 100b in the third embodiment. FIGS. 10 and 9 is a cross-sectional view taken along line X-X in FIG. 9. FIG. 9 illustrates a cross section of the torque transmission mechanism 100b along the X direction and the Y direction. FIG. 10 illustrates a cross section of the torque transmission mechanism 100b along the X direction and the Z direction. As illustrated in FIGS. 9 and 10 , in the present embodiment, unlike the first embodiment, a third groove 162 is provided in a outer peripheral surface 161 of a second member 150b. The torque transmission mechanism 100b further includes a third member 230, one or more second rolling members 250, and a second restriction member 270. The torque transmission mechanism 100b of the present embodiment is the same as that of the first embodiment unless otherwise specified. Note that in the example illustrated in and FIG. 10, the number of the first rolling members 170 and the number of the second rolling members 250 are each four. In FIGS. 9 and 10 , the first groove 132, the second groove 152, and the third groove 162 are schematically indicated by a broken line. In FIGS. 9 and 10 , for example, members such as the first bearing section 201 and the second bearing section 202 are omitted as appropriate.

The third groove 162 has a wave shape extending around the rotation axis AX on the outer peripheral surface 161. Hereinafter, the direction along the trajectory of the third groove 162 is also referred to as a third groove direction. The third groove 162 includes a third curved portion having a curved shape in at least a portion of the third groove 162 in the third groove direction. The third groove 162 is configured, for example, substantially similarly to the first groove 132. In the present embodiment, the third groove 162 has a closed ring shape that makes a full circle around the outer peripheral surface 161 in the circumferential direction DC. The third groove 162 has a periodic wave shape that advances along the circumferential direction DC while reciprocating on the outer peripheral surface 161 along the rotation axis AX as a whole. Specifically, the entire third groove 162 has a shape representing a sine curve. A period T3 of the third groove 162 may be the same as or different from the period T1 and the period T2. The period T3 in the present embodiment is one. The positions of the crest portions of the third groove 162 in the Z direction are substantially the same. The positions of the trough portions of the third groove 162 in the Z direction are substantially the same.

As illustrated in FIG. 9, the third member 230 has an annular shape surrounding the second member 150b. That is, the inner diameter of the third member 230 is larger than the outer diameter of the second member 150. In the present embodiment, the third member 230 is disposed on the outermost side in the horizontal direction among the components of the torque transmission mechanism 100b. The third member 230 is configured to be rotatable about the rotation axis AX. As illustrated in FIG. 9 and FIG. 10, the third member 230 has an inner peripheral surface 231. The inner peripheral surface 231 is provided with a fourth groove 232.

The fourth groove 232 has a wave shape extending around the rotation axis AX on the inner peripheral surface 231. Hereinafter, the direction along the trajectory of the fourth groove 232 is also referred to as a fourth groove direction. The fourth groove 232 includes a fourth curved portion having a curved shape in at least a portion of the fourth groove 232 in the fourth groove direction. The fourth groove 232 is configured, for example, substantially similarly to the second groove 152. The fourth groove 232 has a closed ring shape that makes a full circle around the inner peripheral surface 231 in the circumferential direction DC. The fourth groove 232 has a periodic wave shape that advances along the circumferential direction DC while reciprocating on the inner peripheral surface 231 along the rotation axis AX as a whole. Specifically, the entire fourth groove 232 has a shape representing a sine curve. The fourth groove 232 has a period T4 different from the period T3. That is, the number of the crest portions and the number of the trough portions of the third groove 162 are different from the number of the crest portions and the number of the trough portions of the fourth groove 232. The period T4 may be the same as or different from the period T1 and the period T2. In the present embodiment, the magnitude relationship between the period T4 and the period T3 is the same as the magnitude relationship between the period T2 and the period T1. Specifically, the period T4 in the present embodiment is twelve. The positions of the crest portions of the fourth groove 232 in the Z direction are substantially the same, and are substantially the same as the positions of the crest portions of the third groove 162 in the Z direction. The positions of the trough portions of the fourth groove 232 in the Z direction are substantially the same, and are substantially the same as the positions of the trough portions of the third groove 162 in the Z direction.

The second rolling members 250 are configured substantially similarly to the first rolling members 170, for example. The second rolling members 250 are disposed in the third groove 162 and the fourth groove 232 between the second member 150b and the third member 230. The second rolling members 250 are configured to roll in the third groove 162 and the fourth groove 232. Specifically, as viewed along the radial direction of the torque transmission mechanism 100b, the second rolling members 250 roll in the third groove 162 and the fourth groove 232 so as to be disposed at a position where the third groove 162 and the fourth groove 232 intersect each other. The second rolling members 250 in the present embodiment have a spherical shape similarly to the first rolling member 170. The second rolling members 250 transmit torque between the second member 150b and the third member 230.

The second restriction member 270 is configured substantially similarly to the first restriction member 190, for example. In the present embodiment, the second restriction member 270 has a hollow cylindrical shape as a whole. The second restriction member 270 is disposed between the second member 150b and the third member 230. The second restriction member 270 allows the second rolling member 250 to move along the rotation axis AX and restricts the second rolling member 250 from moving around the rotation axis AX. Note that for example, bearing sections substantially similar to the first bearing section 201 and the second bearing section 202 may be disposed between the second restriction member 270 and the second member 150b and between the second restriction member 270 and the third member 230. That is, such a bearing section holds the second member 150b or the third member 230 so as to be rotatable around the rotation axis AX with respect to the second restriction member 270.

In the present embodiment, as in the first embodiment, deceleration is realized between the first member 130 and the second member 150b via the first rolling member 170. In the present embodiment, deceleration is realized between the second member 150b and the third member 230 via the second rolling member 250. The behavior of the third member 230 with respect to the second member 150b is substantially the same as the behavior of the second member 150b with respect to the first member 130. For example, when the first member 130 is used as an input shaft, the deceleration ratio RR1a is realized between the first member 130 and the second member 150b, and a deceleration ratio RR2a is realized between the second member 150b and the third member 230. The deceleration ratio RR2a corresponds to a value obtained by dividing the period T3 by the period T4. As a result, a deceleration ratio RR3a is realized between the first member 130 as an input shaft and the third member 230 as an output shaft. The deceleration ratio RR3a corresponds to the product of the deceleration ratio RR1a and the deceleration ratio RR2a. When the third member 230 is used as an input shaft, the deceleration ratio RR2b is realized between the third member 230 and the second member 150b, and the deceleration ratio RR1b is realized between the second member 150b and the first member 130. The deceleration ratio RR2b corresponds to a value obtained by dividing the period T4 by the period T3. As a result, a deceleration ratio RR3b is realized between the third member 230 as an input shaft and the first member 130 as an output shaft. The deceleration ratio RR3b corresponds to the product of the deceleration ratio RR1b and the deceleration ratio RR2b. That is, in this case, the rotation input to the torque transmission mechanism 100b is accelerated and output.

According to the torque transmission mechanism 100b in the third embodiment described above, the second rolling member 250 disposed in the third groove 162 provided on the outer peripheral surface 161 of the second member 150b and the second rolling member 250 disposed in the fourth groove 232 provided on the inner peripheral surface 231 of the third member 230 surrounding the second member 150b are configured to roll in the third groove 162 and the fourth groove 232. The movement of the second rolling member 250 along the rotation axis AX is allowed, and the movement of the second rolling member 250 around the rotation axis AX is restricted. The number of the crest portions and the number of the trough portions of the third groove 162 are different from the number of the crest portions and the number of the trough portions of the fourth groove 232. In this way, the rotation speed can be decelerated in a stepwise manner between the first member 130 and the second member 150b and between the second member 150b and the third member 230. Therefore, for example, a higher deceleration ratio can be realized without excessively increasing the period of the second groove 152 and the fourth groove 232. As a result, for example, it is possible to suppress an increase in the size of the second member 150b and the third member 230 due to an increase in the period of the second groove 152 and the fourth groove 232, and thus it is possible to realize a higher deceleration ratio while configuring the torque transmission mechanism 100b in a more space-saving manner. For example, it is possible to suppress excessive downsizing of the first rolling member 170 and the second rolling member 250 due to an increase in the period of the second groove 152 and the fourth groove 232, and thus it is possible to realize a higher deceleration ratio while suppressing a decrease in the endurance of the torque transmission mechanism 100b. Since the third groove 162 has the third curved portion, and the fourth groove 232 has the fourth curved portion, the second rolling member 250 can more smoothly roll in the third groove 162 and the fourth groove 232. As a result, it is possible to suppress damage to the third groove 162 and the fourth groove 232 due to the rolling of the second rolling member 250. Energy loss in the rolling of the second rolling member 250 can be suppressed, and torque can be more efficiently transmitted via the second rolling member 250. Note that in another embodiment, for example, the fourth member may be provided outside the third member 230 so as to realize further stepwise deceleration.

Note that in another embodiment, the curved shape of the first curved portion 133 and the curved shape of the second curved portion 153 may be a first type of curved shape, and the curved shape of the third curved portion and the curved shape of the fourth curved portion may be a second type of curved shape different from the first type. The first type and the second type are selected as types representing the various cam curves described above, for example. In this way, by making the type of the curved shape of the first curved portion 133 and the second curved portion 153 different from the type of the curved shape of the third curved portion and the fourth curved portion, the more sophisticated torque transmission mechanism 100b can be realized. More specifically, for example, when the torque transmission mechanism 100b is used as a deceleration device that decelerates the speed of rotation of the first member 130 and outputs the rotation from the third member 230, a type of curved shape desirable for a higher speed and a lower torque can be applied as the curved shape of the first curved portion 133 and the second curved portion 153, and a type of curved shape desirable for a lower speed and a higher torque can be applied as the curved shape of the third curved portion and the fourth curved portion.

### D. FOURTH EMBODIMENT

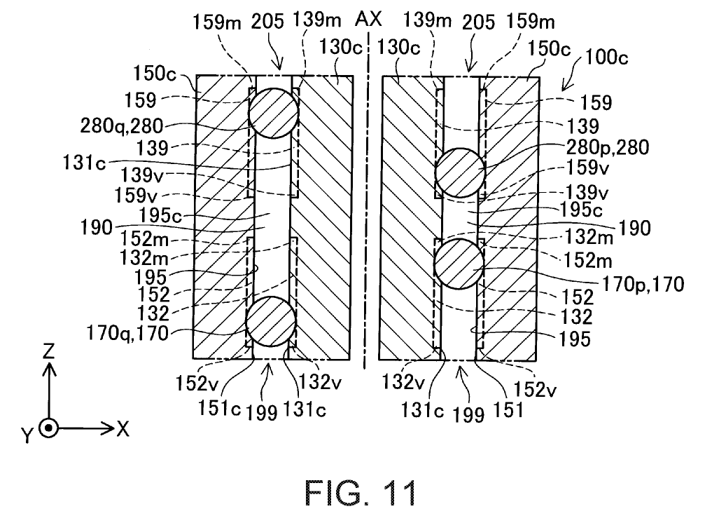

FIG. 11 is a cross-sectional view schematically illustrating a schematic configuration of a torque transmission mechanism 100c in a fourth embodiment. FIG. 11 illustrates a cross section of the torque transmission mechanism 100c along the X direction and the Z direction, substantially similarly to FIG. 10. In the present embodiment, unlike the first embodiment, the first corresponding groove 139 is provided in an outer peripheral surface 131c of the first member 130c. The second corresponding groove 159 is provided in the inner peripheral surface 151c of the second member 150c. One or more third rolling members 280 are disposed in the first corresponding groove 139 and the second corresponding groove 159. The first restriction member 190 has a second restriction section 205. The torque transmission mechanism 100c of the present embodiment is the same as that of the first embodiment unless otherwise specified.

The first corresponding groove 139 is disposed side by side with the first groove 132 in the Z direction. In the present embodiment, the first corresponding groove 139 is disposed on the +Z direction side of the first groove 132. The first corresponding groove 139 is a groove corresponding to the first groove 132, and has a wave shape corresponding to the first groove 132. As a result, the first corresponding groove 139 has a curved portion having the same type of curved shape as the first curved portion 133. The first corresponding groove 139 has the same period as the first groove 132. That is, the first corresponding groove 139 has a periodic wave shape having the same number of crest portions 139m and trough portions 139v as the number of crest portions 132m and trough portions 132v of the first groove 132. In the present embodiment, the first groove 132 and the first corresponding groove 139 are disposed such that the crest portion 132m of the first groove 132 and the trough portion 139v of the first corresponding groove 139 oppose each other. Note that in the first member 130c, for example, a portion where the first groove 132 is provided and a portion where the first corresponding groove 139 is provided may be configured separately from each other, and the first member 130c may be configured by fixing both portions stacked on each other.

The second corresponding groove 159 is disposed side by side with the second groove 152 in the Z direction. In the present embodiment, the second corresponding groove 159 is disposed on the +Z direction side of the second groove 152. The second corresponding groove 159 is a groove corresponding to the second groove 152, and has a wave shape corresponding to the second groove 152. As a result, the second corresponding groove 159 has a curved portion having the same type of curved shape as the second curved portion 153. The second corresponding groove 159 has the same period as the second groove 152. That is, the second corresponding groove 159 has a periodic wave shape having the same number of crest portions 152m and trough portions 152v as the crest portions 159m and the trough portions 159v of the second groove 152. The second corresponding groove 159 has a curved shape similar to that of the first curved portion 133. The number of the crest portion 139m and the number of the trough portion 139v of the first corresponding groove 139 are different from the number of the crest portion 159m and the number of the trough portion 159v of the second corresponding groove 159. In the present embodiment, the second groove 152 and the second corresponding groove 159 are disposed such that the crest portion 152m of the second groove 152 and the trough portion 159v of the second corresponding groove 159 oppose each other. Note that in the second member 150c, for example, a portion where the second groove 152 is provided and a portion where the second corresponding groove 159 is provided may be configured separately, substantially similarly to the first member 130c.

The third rolling members 280 are configured to roll in the first corresponding groove 139 and the second corresponding groove 159. The third rolling members 280 are configured substantially similarly to the first rolling members 170, for example. The third rolling members 280 transmit torque between the first member 130 and the second member 150 in substantially the same manner as the first rolling members 170. The second restriction section 205 allows the third rolling member 280 to move along the rotation axis AX and restricts the third rolling member 280 from moving around the rotation axis AX. The second restriction member 270 is configured substantially similarly to the first restriction section 199, for example. Specifically, in the present embodiment, the first restriction member 190 is provided with slit sections 195c extending from the first groove 132 and the second groove 152 to the first corresponding groove 139 and the second groove 152 in the Z direction, and the slit sections 195c realize the allowance and restriction of the movement of the first rolling member 170 and the third rolling member 280. Note that in another embodiment, for example, the first restriction section 199 and the second restriction section 205 may have separate slit sections, and the slit sections may realize the allowance and restriction of the movement of the first rolling member 170 and the third rolling member 280.

In the present embodiment, at least one of the first rolling member 170 is configured to be, when at least one of the third rolling members 280 is positioned at the trough portion 139v of the first corresponding groove 139, positioned at the crest portion 132m of the first groove 132. At least one first rolling member 170 is configured to be, when at least one of the third rolling member 280 is positioned on the trough portion 159v of the second corresponding groove 159, positioned on the crest portion 152m of the second groove 152. FIG. 11 illustrates a state in which, when one rolling member 170p included in the first rolling members 170 is positioned at the crest portion 132m and the crest portion 152m, one rolling member 280p included in the third rolling members 280 is positioned at the trough portion 139v and the trough portion 159v. A state is illustrated in which, when one rolling member 170q included in the first rolling members 170 is positioned at the trough portion 132v and the trough portion 152v, one rolling member 280q included in the third rolling members 280 is positioned at the crest portion 139m and the crest portion 159m. Note that although not illustrated, when the rolling member 170p is positioned at the trough portion 132v and the trough portion 152v, the rolling member 280p is positioned at the crest portion 139m and the crest portion 159m. Substantially similarly, when the rolling member 170q is positioned at the crest portion 132m and the crest portion 152m, the rolling member 280q is positioned at the trough portion 139v and the trough portion 159v.

According to the torque transmission mechanism 100c in the fourth embodiment described above, the third rolling member 280 disposed in the first corresponding groove 139 provided in the outer peripheral surface 131c of the first member 130c and in the second corresponding groove 159 provided in the inner peripheral surface 151c of the second member 150c are configured to roll in the first corresponding groove 139 and in the second corresponding groove 159. The movement of the third rolling member 280 along the rotation axis AX is allowed, and the movement of the third rolling member 280 around the rotation axis AX is restricted. In this way, torque can be transmitted between the first member 130 and the second member 150 using the first rolling member 170 and the third rolling member 280. Therefore, the load on each rolling member can be reduced. Note that in another embodiment, for example, two or more first corresponding grooves 139 may be provided in the first member 130, and two or more second corresponding grooves 159 may be provided in the second member 150.

In the present embodiment, when the rolling member 170p is positioned at the crest portion 132m and the crest portion 152m, the rolling member 280p is positioned at the trough portion 139v and the trough portion 159v. This configuration allows the first rolling member 170 and the third rolling member 280 to move in opposite directions in the rotation axis AX direction, and can prevent the torque transmission mechanism 100c from swinging in the rotation axis AX direction due to the movement of the first rolling member 170 and the third rolling member 280. In the present embodiment, the first groove 132 and the first corresponding groove 139 are disposed such that the crest portion 132m of the first groove 132 and the trough portion 139v of the first corresponding groove 139 oppose each other. The second groove 152 and the second corresponding groove 159 are disposed such that the crest portion 152m of the second groove 152 and the trough portion 159v of the second corresponding groove 159 oppose each other. In this way, as illustrated in FIG. 11, the first rolling member 170 and the third rolling member 280 can be disposed such that the positions of the first rolling member 170 and the third rolling member 280 in the X direction are the same. As a result, as in the present embodiment, for example, a pair of the first rolling member 170 and the third rolling member 280 is disposed in one slit section 195c, and the slit section 195c can realize the allowance and restriction of the movement of the pair of the first rolling member 170 and the third rolling member 280. In this way, with a simpler configuration, it is possible to suppress the torque transmission mechanism 100c from swinging in the rotation axis AX direction.

### E. FIFTH EMBODIMENT

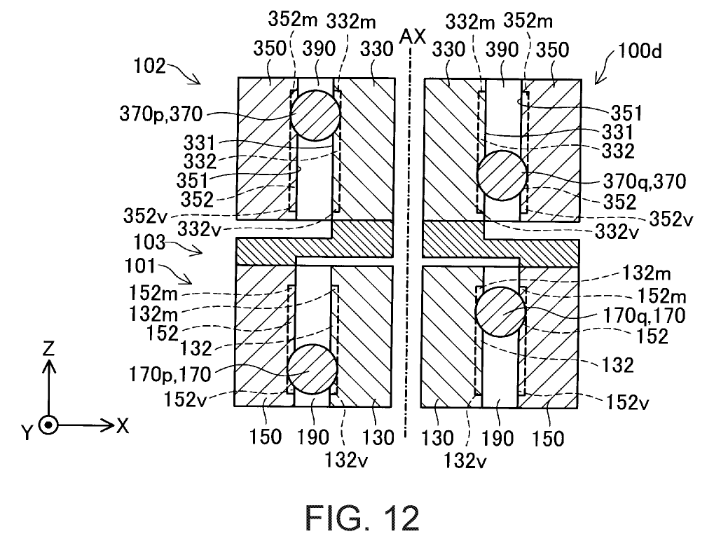

FIG. 12 is a cross-sectional view schematically illustrating a schematic configuration of a torque transmission mechanism 100d in a fifth embodiment. FIG. 12 illustrates a cross section of the torque transmission mechanism 100d along the X direction and the Z direction, substantially similarly to FIGS. 10 and 11 . In the present embodiment, unlike the first embodiment, the torque transmission mechanism 100d includes a first deceleration section 101, a second deceleration section 102, and a coupling member 103. The torque transmission mechanism 100d of the present embodiment is the same as that of the first embodiment unless otherwise specified.

The first deceleration section 101 is configured in the same manner as the torque transmission mechanism 100 in the first embodiment. The second deceleration section 102 is configured substantially similarly to the first deceleration section 101, for example. The second deceleration section 102 is provided with a fourth member 330, a fifth member 350, one or more fourth rolling members 370, and a third restriction member 390. Note that in another embodiment, for example, the components of the second deceleration section 102 and the components of the first deceleration section 101 may be replaced with each other. The second deceleration section 102 is disposed side by side with the first deceleration section 101 in the Z direction. As a result, the fourth member 330 and the fifth member 350 are disposed side by side with the first member 130 and the second member 150 in the Z direction. Specifically, in the present embodiment, by positioning the second deceleration section 102 on the +Z direction side of the first deceleration section 101, the fourth member 330 and the fifth member 350 are disposed on the +Z direction side of the first member 130 and the second member 150.

The fourth member 330 corresponds to the first member 130 in the first deceleration section 101, and is configured substantially similarly to the first member 130, for example. The fourth member 330 has a cylindrical shape. The fourth member 330 is configured to be rotatable about the rotation axis AX. The fourth member 330 has an outer peripheral surface 331 provided with a fifth groove 332. Hereinafter, the direction along the trajectory of the fifth groove 332 is also referred to as a fifth groove direction. The fifth groove 332 includes a fifth curved portion having a curved shape in at least a portion of the fifth groove 332 in the fifth groove direction. The fifth groove 332 is configured substantially similarly to the first groove 132, for example. The fifth groove 332 has a wave shape extending around the rotation axis AX and going around the outer peripheral surface 131 in the circumferential direction DC. The fifth groove 332 is a periodic wave shape having crest portions 332m and trough portions 332v, and has a period T5. The period T5 may be the same as or different from the period T1 and the period T2. The period T5 in the present embodiment is one. In the present embodiment, the first groove 132 and the fifth groove 332 are disposed such that the crest portion 132m of the first groove 132 and the trough portion 332v of the fifth groove 332 oppose each other.

The fifth member 350 corresponds to the second member 150 in the first deceleration section 101, and is configured substantially similarly to the second member 150, for example. The fifth member 350 has an annular shape surrounding the fourth member 330. The fifth member 350 is configured to be rotatable about the rotation axis AX. The fifth member 350 has an inner peripheral surface 351 provided with a sixth groove 352. Hereinafter, the direction along the trajectory of the sixth groove 352 is also referred to as a sixth groove direction. The sixth groove 352 includes a sixth curved portion having a curved shape in at least a portion of the sixth groove 352 in the sixth groove direction. The sixth groove 352 is configured substantially similarly to the second groove 152, for example. The sixth groove 352 has a wave shape extending around the rotation axis AX and going around the inner peripheral surface 351 in the circumferential direction DC. The sixth groove 352 is a periodic wave shape having a crest portions 352m and a trough portions 352v. The number of the crest portions 332m and the number of the trough portions 332v of the fifth groove 332 are different from the number of the crest portions 352m and the number of the trough portions 352v of the sixth groove 352. That is, a period T6 of the sixth groove 352 is different from the period T5 of the fifth groove 332. The period T6 may be the same as or different from the period T1 and the period T2. In the present embodiment, the magnitude relationship between the period T6 and the period T5 is the same as the magnitude relationship between the period T2 and the period T1. Specifically, the period T6 in the present embodiment is 12. In the present embodiment, the second groove 152 and the sixth groove 352 are disposed such that the crest portion 152m of the second groove 152 and the trough portion 352v of the sixth groove 352 oppose each other.

The fourth rolling members 370 correspond to the first rolling members 170 in the first deceleration section 101, and are configured substantially similarly to the first rolling members 170, for example. The fourth rolling members 370 are disposed in the fifth groove 332 and the sixth groove 352, and are configured to roll in the fifth groove 332 and the sixth groove 352.

The third restriction member 390 corresponds to the first restriction member 190 in the first deceleration section 101, and is configured substantially similarly to the first restriction member 190, for example. The third restriction member 390 is disposed between the fourth member 330 and the fifth member 350. The third restriction member 390 allows the fourth rolling member 370 to move along the rotation axis AX and restricts the fourth rolling member 370 from moving around the rotation axis AX. The third restriction member 390 realizes, for example, the allowance and restriction of the movement of the fourth rolling member 370 by a slit section, similarly to the first restriction member 190.

The coupling member 103 couples the first deceleration section 101 and the second deceleration section 102. More specifically, the coupling member 103 couples the second member 150 and the fourth member 330 to each other so as to be rotatable around the rotation axis AX. In the present embodiment, the coupling member 103 is disposed between the second member 150 and the fourth member 330 in the Z direction, and is fixed to the upper end section of the second member 150 and the lower end section of the fourth member 330.

In the present embodiment, substantially similarly to the third embodiment, the rotational speed can be decelerated in a stepwise manner between the first member 130 and the second member 150 in the first deceleration section 101 and between the fourth member 330 and the fifth member 350 in the second deceleration section 102. Specifically, for example, when the first member 130 is used as an input shaft, the deceleration ratio RR1a is realized between the first member 130 and the second member 150 in the first deceleration section 101. At this time, the rotation of the second member 150 is transmitted to the fourth member 330 via the coupling member 103. In the second deceleration section 102, deceleration is realized between the fourth member 330 and the fifth member 350 via the fourth rolling member 370. In this case, the deceleration ratio RR4a realized between the fourth member 330 and the fifth member 350 corresponds to a value obtained by dividing the period T5 by the period T6. As a result, a deceleration ratio RR5a is realized between the first member 130 as an input shaft and the fifth member 350 as an output shaft. The deceleration ratio RR5a corresponds to the product of the deceleration ratio RR1a and the deceleration ratio RR4a. When the fifth member 350 is used as the input shaft, the deceleration ratio RR4b is realized between the fifth member 350 and the fourth member 330 in the second deceleration section 102, and the deceleration ratio RR1b is realized in the first deceleration section 101. As a result, a deceleration ratio RR5b is realized between the fifth member 350 as an input shaft and the first member 130 as an output shaft. The deceleration ratio RR5b corresponds to the product of the deceleration ratio RR1b and the deceleration ratio RR4b. That is, in this case, the rotation input to the torque transmission mechanism 100d is accelerated and output.

In the present embodiment, at least one of the first rolling members 170 is configured to be, when at least one of the fourth rolling members 370 is positioned on the trough portion 332v of the fifth groove 332, positioned on the crest portion 132m of the first groove 132. The first rolling member 170 is configured to be, when at least one of the fourth rolling members 370 is positioned on the trough portion 352v of the sixth groove 352, positioned on the crest portion 152m of the second groove 152. FIG. 12 illustrates a state in which, when one rolling member 170p included in the first rolling members 170 is positioned at the crest portion 132m and the crest portion 152m, one rolling member 370p included in the fourth rolling members 370 is positioned at the trough portion 332v and the trough portion 352v. A state is illustrated in which, when one rolling member 170q included in the first rolling members 170 is positioned at the trough portion 132v and the trough portion 152v, one rolling member 370q included in the fourth rolling members 370 is positioned at the crest portion 332m and the crest portion 352m. Note that although not illustrated, when the rolling member 170p is positioned at the trough portion 132v and the trough portion 152v, the rolling member 370p is positioned at the crest portion 332m and the crest portion 352m. Substantially similarly, when the rolling member 170q is positioned at the crest portion 132m and the crest portion 152m, the rolling member 370q is positioned at the trough portion 332v and the trough portion 352v.

According to the torque transmission mechanism 100d in the fifth embodiment described above, the first deceleration section 101 and the second deceleration section 102 are disposed side by side in the Z direction, and the second member 150 of the first deceleration section 101 and the fourth member 330 of the second deceleration section 102 are coupled to each other by the coupling member 103 so as to be rotatable around the rotation axis AX. In the second deceleration section 102, the fourth rolling member 370 disposed in the fifth groove 332 of the fourth member 330 and the sixth groove 352 of the fifth member 350 are configured to roll in the fifth groove 332 and the sixth groove 352. In the fifth groove 332 and the sixth groove 352, the movement of the fourth rolling member 370 along the rotation axis AX is allowed, and the movement of the fourth rolling member 370 around the rotation axis AX is allowed. The number of the crest portions 332m and the number of the trough portions 332v of the fifth groove 332 are different from the number of the crest portions 352m and the number of the trough portions 352v of the sixth groove 352. Therefore, the rotational speed can be decelerated in a stepwise manner between the first member 130 and the second member 150 and between the fourth member 330 and the fifth member 350, and a higher deceleration ratio can be realized while the torque transmission mechanism 100d is configured to be more space-saving in the radial direction. Since the fifth groove 332 has the fifth curved portion and the sixth groove 352 has the sixth curved portion, the fourth rolling member 370 can be more smoothly rolled in the fifth groove 332 and the sixth groove 352. As a result, it is possible to suppress damage to the fifth groove 332 and the sixth groove 352 due to the rolling of the fourth rolling member 370. Energy loss in the rolling of the fourth rolling member 370 can be suppressed, and torque can be more efficiently transmitted via the fourth rolling member 370. Note that in another embodiment, to realize further stepwise speed deceleration, another deceleration section may be coupled to the first deceleration section 101 or the second deceleration section 102, for example. For example, by combining the configuration of the fourth embodiment with the configuration of the fifth embodiment, further stepwise deceleration may be realized.

In the present embodiment, when the rolling member 170p is positioned at the crest portion 132m and the crest portion 152m, the rolling member 370p is positioned at the trough portion 332v and the trough portion 352v. This configuration allows the first rolling member 170 and the fourth rolling member 370 to move in opposite directions in the rotation axis AX direction, and prevents the torque transmission mechanism 100d from swinging in the rotation axis AX direction due to the movement of the first rolling member 170 and the fourth rolling member 370.

Note that in another embodiment, the curved shape of the first curved portion 133 and the curved shape of the second curved portion 153 may be a first type of curved shape, and the curved shape of the fifth curved portion and the curved shape of the sixth curved portion may be a third type of curved shape different from the first type. The third type is selected as a type representing the various cam curves described above, for example. In this way, by making the types of the curved shapes of the first curved portion 133 and the second curved portion 153 different from the types of the curved shapes of the fifth curved portion and the sixth curved portion, the more sophisticated torque transmission mechanism 100d can be realized. For example, when the torque transmission mechanism 100d is used as a deceleration device that decelerates the speed of rotation of the first member 130 and outputs the rotation from the fifth member 350, a type of curved shape desirable for a higher speed and a lower torque can be applied as the curved shape of the first curved portion 133 and the second curved portion 153, and a type of curved shape desirable for a lower speed and a higher torque can be applied as the curved shape of the fifth curved portion and the sixth curved portion.

### F. SIXTH EMBODIMENT

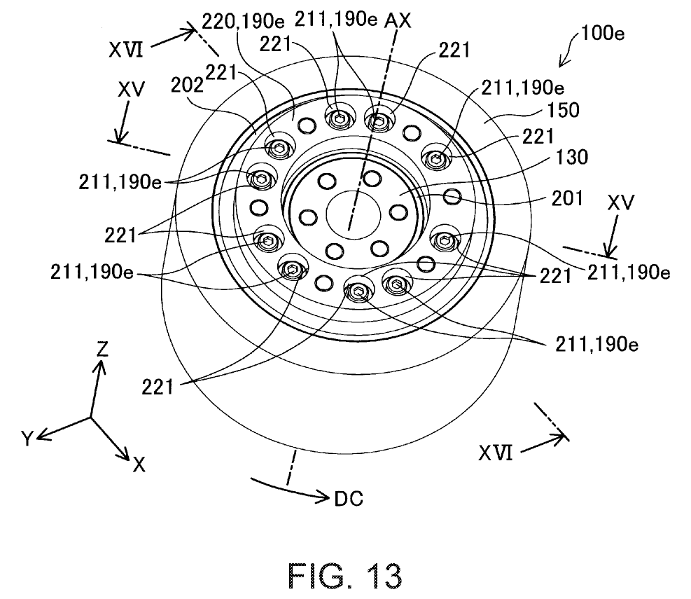

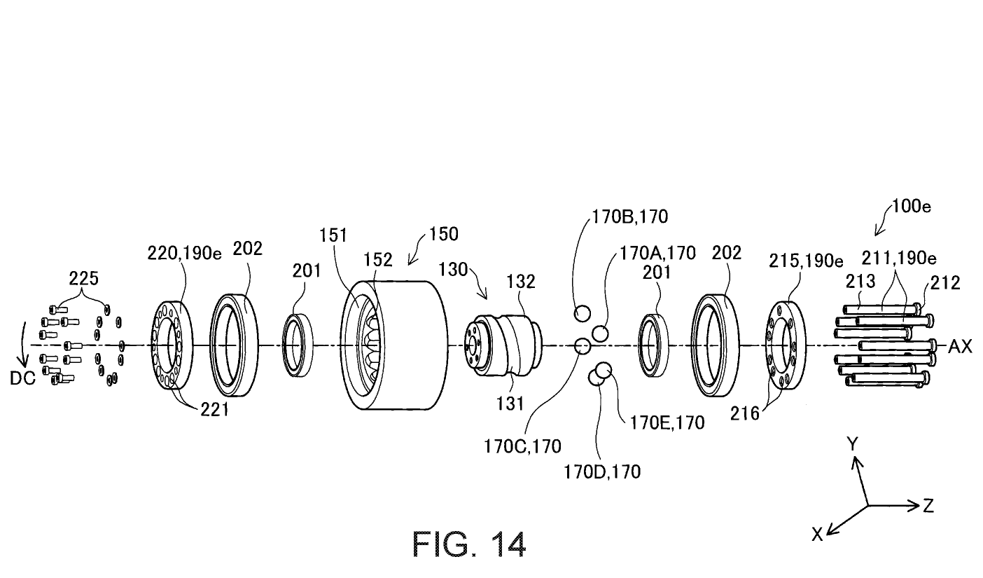

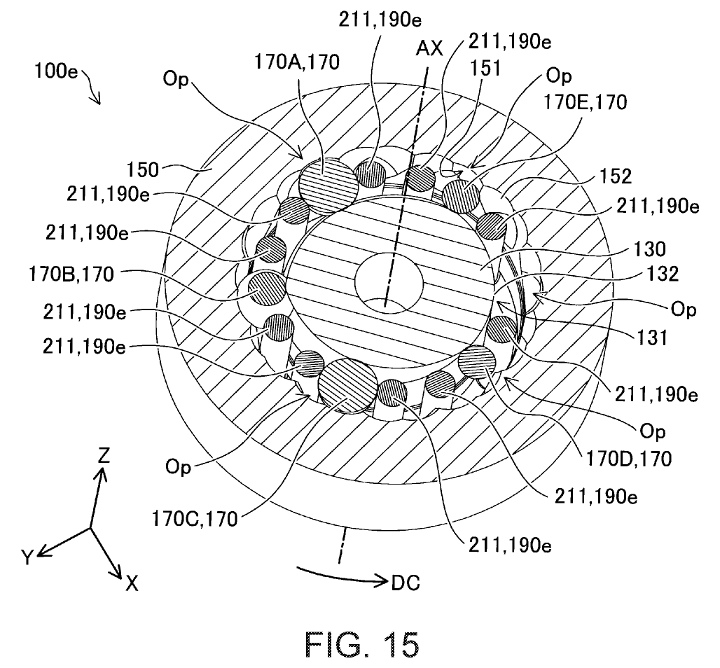

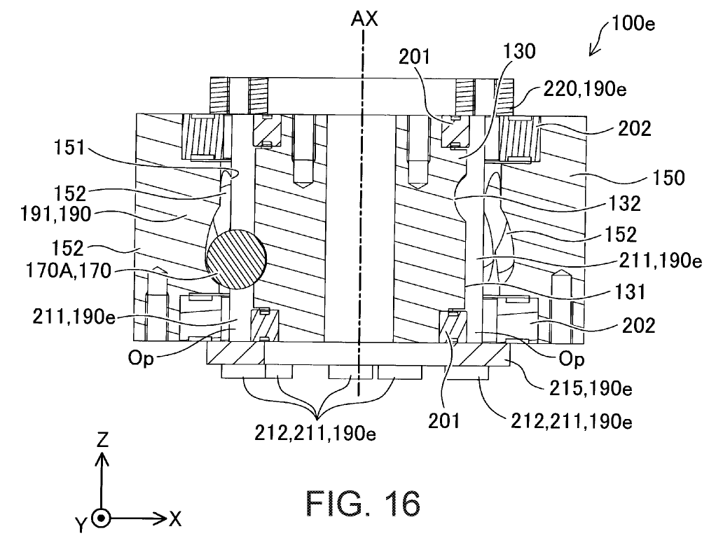

FIG. 13 is a perspective view illustrating a schematic configuration of a torque transmission mechanism 100e in the sixth embodiment. FIG. 14 is an exploded perspective view illustrating a schematic configuration of the torque transmission mechanism 100e. FIG. 15 is a cross-sectional view taken along line XV-XV in FIG. 13. FIG. 16 is a cross-sectional view taken along line XVI-XVI in FIG. 13. In the present embodiment, the configuration of a first restriction member 190e is different from that of the first embodiment. The torque transmission mechanism 100e of the present embodiment is the same as that of the first embodiment unless otherwise specified.

As illustrated in FIG. 13, FIGS. 14 and 16, , the first restriction member 190e in the present embodiment is provided with columnar members 211, a first annular member 215, and a second annular member 220.

The first annular member 215 has an annular shape. The first annular member 215 is disposed such that an axial direction of the first annular member 215 is along the Z direction. The first annular member 215 is provided with a plurality of first through holes 216. The first through holes 216 penetrate the first annular member 215 in the Z direction. In the present embodiment, the first annular member 215 is provided with ten first through holes 216.

The second annular member 220 has an annular shape. The second annular member 220 is disposed such that an axial direction of the second annular member 220 is along the Z direction. The second annular member 220 is provided with a plurality of second through holes 221. The second through holes 221 penetrates the second annular member 220 in the Z direction. In the present embodiment, the second annular member 220 is provided with ten second through holes 221 corresponding to the ten first through holes 216.

In the present embodiment, ten columnar members 211 are provided corresponding to the ten first through holes 216 and the ten second through holes 221. The columnar member 211 has a cylindrical shape as a whole. The columnar member 211 is disposed such that an axial direction of the columnar member 211 is along the Z direction. The columnar member 211 has a head portion 212 and a shaft portion 213. The head portion 212 has a diameter larger than the opening diameter of the first through hole 216 and the opening diameter of the second through hole 221. The head portion 212 constitutes an upper end section of the columnar member 211. The shaft portion 213 has a diameter slightly smaller than the opening diameter of the first through hole 216 and the opening diameter of the second through hole 221. Each columnar member 211 is inserted into the second through hole 221 and the first through hole 216 from the +Z direction side. That is, the shaft portion 213 of each columnar member 211 is disposed in the first through hole 216 and the second through hole 221. The head portion 212 of each columnar member 211 is disposed on the +Z direction side of the second annular member 220. The lower end section of each columnar member 211 is fixed to the first annular member 215 via a fixing member 225 and the first through hole 216. The fixing member 225 is configured by, for example, a bolt and a washer. With this configuration, the columnar members 211 are connected to each other in the horizontal direction by the first annular member 215 and the second annular member 220.

As illustrated in FIG. 14 and FIG. 16, since the columnar members 211 are connected to each other in the horizontal direction, an opening section is formed between the columnar members 211 adjacent to each other in the circumferential direction DC. In the present embodiment, the first rolling member 170 is disposed in five opening sections Op among the opening sections. The opening width of each opening section Op in the circumferential direction DC is slightly larger than the diameter of the first rolling member 170. The opening length of each opening section Op in the Z direction is larger than the opening width of each opening section Op. The opening section Op allows the movement of each first rolling member 170 in the Z direction and restricts the movement of each first rolling member 170 around the rotation axis AX, substantially similarly to the slit section 195 described in the first embodiment. Specifically, the movement of the first rolling member 170 around the rotation axis AX is restricted by the columnar member 211 that defines the opening section Op. In this manner, the first restriction member 190e in the present embodiment realizes, by the opening section Op, the allowance and restriction of the movement of each first rolling member 170. Note that the first restriction member 190e and the first restriction member 190 described in the first embodiment are similar to each other in that the groove shaped opening extending in the Z direction allows and regulates the movement of the first rolling member 170.

According to the torque transmission mechanism 100e of the sixth embodiment described above, the rotational speed can also be decelerated between the first member 130 and the second member 150 according to the first groove 132 and the second groove 152 via the first rolling member 170 without using a pin for torque transmission. It is possible to suppress damage to the first groove 132 and the second groove 152 due to the rolling of the first rolling member 170. Energy loss in the rolling of the first rolling member 170 can be suppressed, and torque can be more efficiently transmitted via the first rolling member 170.

Note that the same configuration as that of the first restriction member 190e in the sixth embodiment may be applied to, for example, the second restriction member 270 described in the third embodiment or the third restriction member 390 described in the fifth embodiment.

### G. OTHER EMBODIMENTS

(G-1) In each of the above embodiments, the first curved portion 133 includes at least one of the crest portion 132m and the trough portion 132v, but may not include the crest portion 132m and the trough portion 132v. That is, as long as the first curved portion 133 is included in at least a part of the first groove 132, the crest portion 132m and the trough portion 132v of the first groove 132 may not have a curved shape. Similarly, the second curved portion 153 may not include the crest portion 152m and the trough portion 152v. The third curved portion, the fourth curved portion, the fifth curved portion, and the sixth curved portion may not include the crest portion and the trough portion of the third groove 162, the crest portion and the trough portion of the fourth groove 232, the crest portion 332m and the trough portion 332v of the fifth groove 332, and the crest portion 332m and the trough portion 352v of the sixth groove 352, respectively.

(G-2) In each of the above embodiments, the first rolling member 170 has a spherical shape. In contrast, the first rolling member 170 may not be spherical as long as it can roll in the first groove 132 and the second groove 152. For example, the first rolling member 170 may have a curved surface shape different from a spherical shape, which is capable of rolling in the first groove 132 and the second groove 152.

(G-3) In each of the above embodiments, the plurality of first rolling members 170 are provided. In contrast, the number of the first rolling members 170 may be one. The number of the first rolling members 170 and the arrangement of the first rolling members 170 may be arbitrary as long as the torque transmission mechanism 100 can transmit torque and the first rolling members 170 can be disposed in the first groove 132 and the second groove 152. For example, the number of the first rolling members 170 may be two or more and four or less, or may be six or more. Substantially similarly, the number and arrangement of the second rolling members 250, the third rolling members 280, and the fourth rolling members 370 may be arbitrary. The number of the first rolling members 170, the number of the second rolling members 250, the number of the third rolling members 280, and the number of the fourth rolling members 370 may be the same or different from each other.

(G-4) In each of the above embodiments, the first bearing section 201 is provided, but may not be provided. Substantially similarly, the second bearing section 202 may not be provided.

(G-5) In each of the above embodiments, the period T1 of the first groove 132 is smaller than the period T2 of the second groove 152, but the period T1 may be larger than the period T2. In this case, when the first member 130 is used as an input shaft, acceleration is realized between the first member 130 and the second member 150. When the second member 150 is used as an input shaft, acceleration is realized between the second member 150 and the first member 130. Substantially similarly, the period T3 may be larger than the period T4. Substantially similarly, the period T5 may be larger than the period T6.

(G-6) In each of the above embodiments, the type of the curved shape of the first curved portion 133 and the type of the curved shape of the second curved portion 153 are the same. In contrast, for example, when the number of the first rolling members 170 is one, the type of the curved shape of the first curved portion 133 and the type of the curved shape of the second curved portion 153 may be different from each other. Similarly, the type of the curved shape of the third curved portion and the type of the curved shape of the fourth curved portion may be different from each other. The type of the curved shape of the fifth curved portion and the type of the curved shape of the sixth curved portion may be different from each other. The type of the curved shape of the curved portion of the first corresponding groove 139 and the type of the curved shape of the curved portion of the second corresponding groove 159 may be different from each other.

(G-7) In each of the above embodiments, the number of the crest portions 132m and the number of the trough portions 132v of the first groove 132 are different from the number of the crest portions 152m and the number of the trough portions 152v of the second groove 152, but may be the same. In this case, the period T1 of the first groove 132 and the period T2 of the second groove 152 are the same. That is, the torque transmission mechanism 100 may not be configured as a deceleration device.

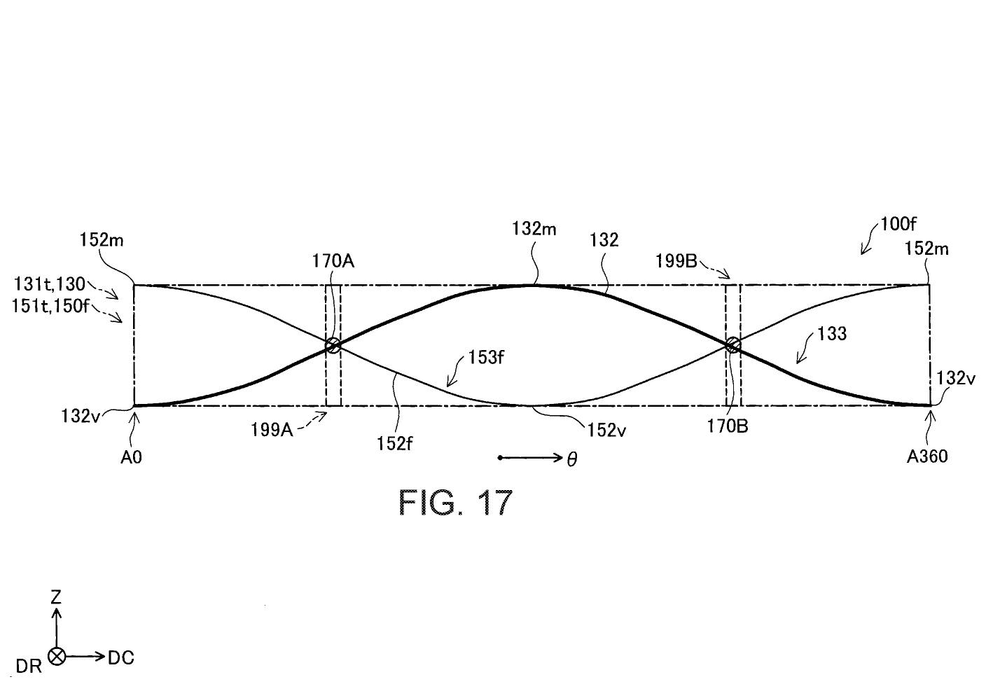

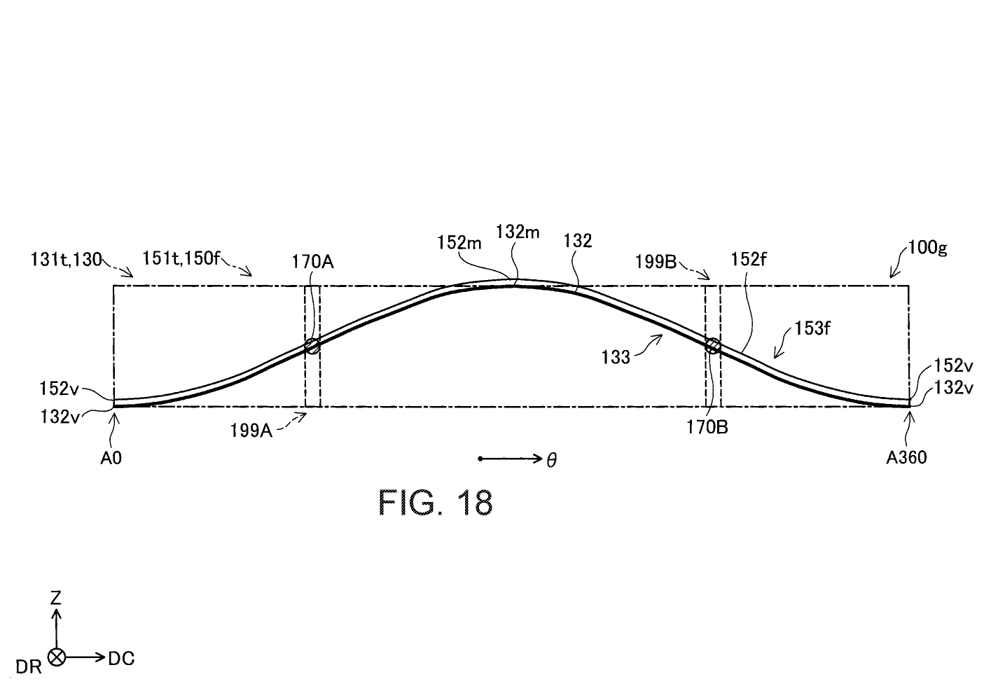

For example, FIG. 17 is an explanatory diagram of a torque transmission mechanism 100f, which is a first example of a torque transmission mechanism in another embodiment. FIG. 18 is an explanatory diagram of a torque transmission mechanism 100g, which is a second example of the torque transmission mechanism in another embodiment. In FIGS. 17 and 8 , the outer peripheral surface 131t and the inner peripheral surface 151t are illustrated substantially similarly to FIG. 5. In the example of FIGS. 17 and 18 , an entire second groove 152f represents a sine curve. The second groove 152f includes a second curved portion 153f having a curved shape according to a sine curve. In the example of FIGS. 17 and 18 , the number of the crest portions 132m and the number of the trough portions 132v of the first groove 132 are the same as the number of the crest portions 152m and the number of the trough portions 152v of the second groove 152f, respectively, and are one. In the example of FIGS. 17 and 18 , the rolling member 170A and the rolling member 170B are provided as the first rolling member 170, and the restriction section 199A and the restriction section 199B are provided as the first restriction section 199. In the example of FIG. 17, the first member 130 and the second member 150f are disposed such that the crest portion 132m of the first groove 132 and the trough portion 152v of the second groove 152f are disposed at the same position in the circumferential direction DC, that is, the phases of the first groove 132 and the second groove 152f are opposite to each other when the outer peripheral surface 131t and the inner peripheral surface 151t are viewed along the radial direction DR. In this way, when rotation is input to one of the first member 130 and the second member 150f, rotation in the opposite direction to the input rotation can be output from the other. As illustrated in FIG. 18, the first member 130 and the second member 150f can be disposed such that the crest portion 132m of the first groove 132 and the crest portion 152m of the second groove 152f are disposed at the same position in the circumferential direction DC, that is, the phases of the first groove 132 and the second groove 152f are the same when the outer peripheral surface 131t and the inner peripheral surface 151t are viewed along the radial direction DR. Note that in FIG. 18, the first groove 132 and the second groove 152f are illustrated to be shifted from each other to facilitate understanding of the technology, but the first groove 132 and the second groove 152f actually overlap each other. In this way, when rotation is input to one of the first member 130 and the second member 150f, rotation in the same direction as the input rotation can be output from the other. In this way, even if the period T1 and the period T2 are the same, torque transmission can be realized between the first member 130 and the second member 150f without using a pin for torque transmission. A normal rotation type torque transmission mechanism that outputs rotation in the same direction as the input rotation and a reverse rotation type torque transmission mechanism that outputs rotation in the opposite direction to the input rotation can be easily configured using the same first member 130, second member 150f, and first restriction member 190.

(G-8) In the fourth embodiment, the crest portion 132m of the first groove 132 and the trough portion 139v of the first corresponding groove 139 face each other, and the crest portion 152m of the second groove 152 and the trough portion 159v of the second corresponding groove 159 face each other. However, the crest portion 132m and the trough portion 139v may not face each other. The crest portion 152m and the trough portion 159v may not face each other. In this case, for example, the crest portion 132m and the trough portion 139v face each other, but the crest portion 152m and the trough portion 159v may not face each other. For example, the crest portion 152m and the trough portion 159v face each other, but the crest portion 132m and the trough portion 139v may not face each other. Substantially similarly, in the fifth embodiment, the crest portion 132m of the first groove 132 and the trough portion 332v of the fifth groove 332 may not face each other. The crest portion 152m of the second groove 152 and the trough portion 352v of the sixth groove 352 may not face each other.

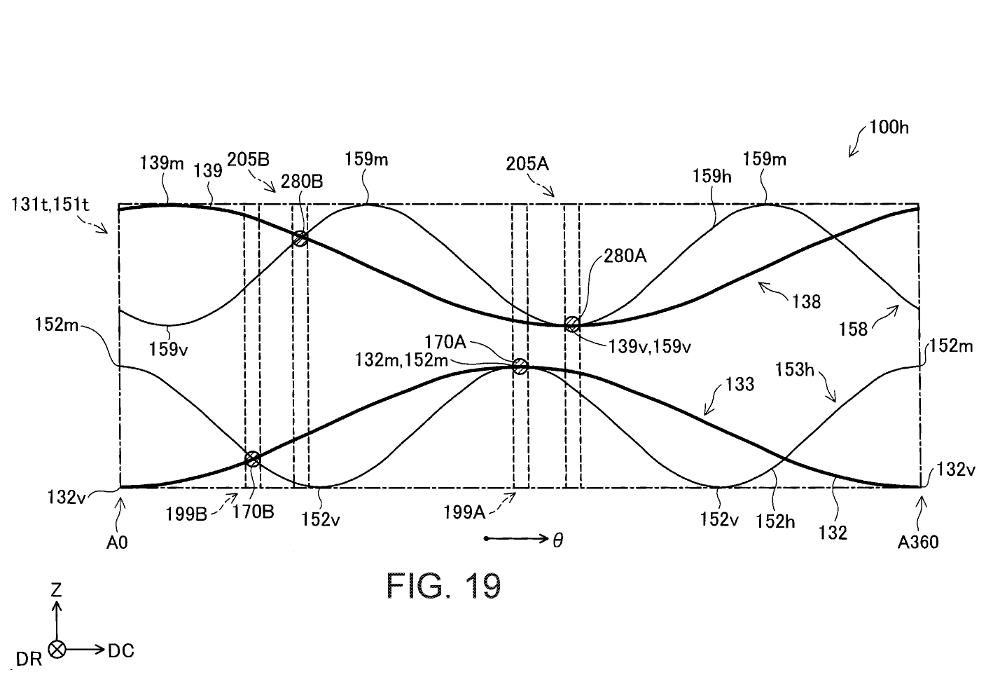

FIG. 19 is an explanatory diagram of a torque transmission mechanism 100h as a third example of the torque transmission mechanism in another embodiment. In FIG. 19, the outer peripheral surface 131t and the inner peripheral surface 151t are illustrated substantially similarly to FIG. 5. The torque transmission mechanism 100h is provided with the first groove 132 and the first corresponding groove 139, and the second groove 152h and the second corresponding groove 159h, as in the fourth embodiment. The first corresponding groove 139 has a first corresponding curved portion 138 having the same type of curved shape as the first curved portion 133. The second corresponding groove 159h includes a second corresponding curved portion 158 having the same type of curved shape as the second curved portion 153h. In the example of FIG. 19, the number of the crest portions 152m and the number of the trough portions 152v of the second groove 152h, and the number of the crest portions 159m and the number of the trough portions 159v of the second corresponding groove 159h are each two. In the example of FIG. 19, the rolling member 170A and the rolling member 170B are provided as the first rolling member 170, and the restriction section 199A and the restriction section 199B are provided as the first restriction section 199. A rolling member 280A and a rolling member 280B are provided as the third rolling member 280, and a restriction section 205A and a restriction section 205B are provided as the second restriction section 205. The restriction section 205A and 205B each have the slit section extending in the Z direction, substantially similarly to the restriction section 199A and the restriction section 199B. The restriction sections 205A and 205B allow the rolling members 280A and 280B to move along the rotation axis AX and restrict the rolling members 280A and 280B from moving around the rotation axis AX by the slit sections. In the example of FIG. 19, unlike the fourth embodiment, the crest portion 132m and the trough portion 139v do not face each other, and the crest portion 152m and the trough portion 159v do not face each other. However, in the example of FIG. 19, as in the fourth embodiment, at least one of the first rolling members 170 is positioned on the crest portion 132m of the first groove 132 when at least one of the third rolling members 280 is positioned on the trough portion 139v of the first corresponding groove 139. At least one first rolling members 170 is positioned on the crest portion 152m of the second groove 152 when at least one of the third rolling members 280 is positioned on the trough portion 159v of the second corresponding groove 159h. Note that FIG. 19 illustrates a state in which the rolling member 170A is positioned at the crest portion 132m and the crest portion 152m, and the rolling member 280A is positioned at the trough portion 139v and the trough portion 159v. In this way, similarly to the fourth embodiment, it is possible to suppress the torque transmission mechanism 100h from swinging in the Z direction due to the movement of the first rolling member 170 and the third rolling member 280. In this way, even in a configuration in which the crest portion 132m and the trough portion 139v do not face each other and the crest portion 152m and the trough portion 159v do not face each other, it is possible to suppress the torque transmission mechanism 100h from swinging in the Z direction.

### H. OTHER FORMS

The present disclosure is not limited to the embodiments described above, but can be realized in various forms without departing from the scope of the present disclosure. For example, the present disclosure can also be realized by the following forms. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

(1) According to one aspect of the present disclosure, a torque transmission mechanism is provided.

The torque transmission mechanism includes first member that has a cylindrical shape and that is configured to be rotatable around a rotation axis, the first member having an outer peripheral surface provided with a first groove extending around the rotation axis; a second member that has an annular shape surrounding the first member and that is configured to be rotatable around the rotation axis, the second member having an inner peripheral surface provided with a second groove extending around the rotation axis; one or more first rolling members that are disposed in the first groove and the second groove and that are configured to roll in the first groove and the second groove; and a first restriction member that is disposed between the first member and the second member, that is configured to allow movement of the first rolling members along the rotation axis, and that is configured to restrict movement of the first rolling members around the rotation axis.

The first groove and the second groove are formed in a periodic wave shape having one or more crest portions and trough portions around the rotation axis.

The first groove includes a first curved portion having a curved shape in at least a part of the first groove.

the second groove includes a second curved portion having a curved shape in at least a part of the second groove.

According to this aspect, torque can be transmitted between the first member and the second member via the first rolling members in accordance with the first groove and the second groove without using a pin for torque transmission. The first groove has the first curved portion and the second groove has the second curved portion, thereby the first rolling members can be more smoothly rolled in the first groove and the second groove. As a result, it is possible to suppress damage to the first groove and the second groove due to the rolling of the first rolling members. Energy loss in the rolling of the first rolling members can be suppressed, and torque can be more efficiently transmitted via the first rolling members.

(2) The above aspect may be such that the first curved portion includes at least one of the crest portion and the trough portion of the first groove.

According to this aspect, the first rolling members rolling in the first groove can be caused to pass through the crest portion and the trough portion more smoothly, and damage to the first groove due to rolling of the first rolling members and energy loss due to the rolling of the first rolling members can be more effectively suppressed.

(3) The above aspect may be such that the second curved portion includes at least one of the crest portion and the trough portion of the second groove.

According to this aspect, the first rolling members rolling in the second groove can be caused to pass through the crest portion and the trough portion more smoothly, and damage to the second groove due to rolling of the first rolling members and energy loss in rolling of the first rolling members can be more effectively suppressed.

(4) The above aspect may be such that the first curved portion includes at least one of the crest portion and the trough portion of the first groove, the second curved portion includes at least one of the crest portion and the trough portion of the second groove, and the curved shape of the first curved portion and the curved shape of the second curved portion include at least one of a shape according to a sine curve and an arc shape.

According to this aspect, the first curved portion and the second curved portion are more simply configured, and the first rolling members can be more smoothly rolled in the first groove and the second groove.

(5) The above aspect may be such that the entire first groove and the entire second groove have a shape representing the sine curve.

According to this aspect, the configuration further simplifies the configuration of the first groove and the second groove.

(6) The above aspect may be such that the entire first groove and the entire second groove have a shape representing a modified constant velocity curve.

According to this aspect, the first rolling members can be rolled more smoothly in the first groove and the second groove, and an increase in the maximum speed of the first rolling members can be suppressed.

(7) The above aspect may be such that the first groove and the second groove have a shape obtained by combining two or more of a sine curve, a modified constant velocity curve, a cycloid curve, a modified trapezoid curve, a one-dwell modified trapezoid curve, a modified sine curve, and a one-dwell modified sine curve.

According to this aspect, applying various cam curves to the first groove and the second groove, thereby possible to easily realize the torque transmission mechanism having a higher function.

(8) The above aspect may be such that the number of the crest portions and the number of the trough portions of the first groove are different from the number of the crest portions and the number of the trough portions of the second groove.

According to this aspect, the rotational speed can be decelerated between the first member and the second member according to the number of the crest portions and the trough portions of the first groove and the number of the crest portions and the trough portions of the second groove.

(9) The above aspect may be such that the first rolling members have a spherical shape.

According to this aspect, the first rolling members can be rolled more smoothly.

(10) The above aspect may be such that the first rolling members include one rolling member and an other rolling member and the first restriction member has one restriction section configured to allow movement of the one rolling member along the rotation axis and to restrict movement of the first rolling members around the rotation axis, and an other restriction section configured to allow movement of the other rolling member along the rotation axis and to restrict movement of the other rolling member around the rotation axis.

According to this aspect, the load on each rolling members can be reduced.

(11) The above aspect form may further include a first bearing section that is disposed between the first member and the first restriction member and that is configured to hold the first member rotatably with respect to the first restriction member.

According to this aspect, the first member can be more smoothly rotated with respect to the first restriction member via the first bearing section.

(12) The above aspect form may further include a second bearing section that is disposed between the second member and the first restriction member and that is configured to hold the second member rotatably with respect to the first restriction member.

According to this aspect, the second member can be more smoothly rotated with respect to the first restriction member via the second bearing section.

(13) The above aspect may be such that a third groove extending around the rotation axis is provided on an outer peripheral surface of the second member, the torque transmission mechanism further includes a third member that has an annular shape surrounding the second member and that is configured to be rotatable around the rotation axis, the third member having an inner peripheral surface provided with a fourth groove extending around the rotation axis, one or more second rolling members that are disposed in the third groove and the fourth groove and that are configured to roll in the third groove and the fourth groove, and a second restriction member that is disposed between the second member and the third member, that is configured to allow movement of the second rolling members along the rotation axis, and that is configured to restrict movement of the second rolling members around the rotation axis, the third groove and the fourth groove are formed in the wave shape having one or more of the crest portions and the trough portions around the rotation axis, the third groove includes a third curved portion having a curved shape in at least a part of the third groove, the fourth groove includes a fourth curved portion having a curved shape in at least a part of the fourth groove, and the number of the crest portions and the number of the trough portions of the third groove are different from the number of the crest portions and the number of the trough portions of the fourth groove.

According to this aspect, the rotational speed can be decelerated in a stepwise manner between the first member and the second member and between the second member and the third member, and a higher deceleration ratio can be realized. The third groove has the third curved portion and the fourth groove has the fourth curved portion, thereby the second rolling members can be more smoothly rolled in the third groove and the fourth groove. As a result, it is possible to suppress damage to the third groove and the fourth groove due to the rolling of the second rolling members. Energy loss in the rolling of the second rolling members can be suppressed, and torque can be more efficiently transmitted via the second rolling members.

(14) The above aspect may be such that the curved shape of the first curved portion and the curved shape of the second curved portion are each a first type of curved shape and the curved shape of the third curved portion and the curved shape of the fourth curved portion are each a second type of curved shape different from the first type of curved shape.

According to this aspect, the curved shape of the first curved portion and the second curved portion is different from the curved shape of the third curved portion and the fourth curved portion, thereby a more sophisticated torque transmission mechanism can be realized. For example, when the torque transmission mechanism is used as a deceleration device that decelerates the speed of rotation of the first member and outputs the rotation from the third member, a type of curved shape desirable for a higher speed and a lower torque can be applied as the curved shape of the first curved portion and the second curved portion, and a type of curved shape desirable for a lower speed and a higher torque can be applied as the curved shape of the third curved portion and the fourth curved portion.

(15) The above aspect may be such that the first member has an outer peripheral surface provided with a first corresponding groove having the wave shape corresponding to the first groove, the first corresponding groove being disposed side by side with the first groove in the direction of the rotation axis, the second member has an inner peripheral surface provided with a second corresponding groove having the wave shape corresponding to the second groove, the second corresponding groove being disposed side by side with the second groove in the direction of the rotation axis, the torque transmission mechanism further includes one or more third rolling members that are disposed in the first corresponding groove and the second corresponding groove and that are configured to roll in the first corresponding groove and the second corresponding groove, and the first restriction member is further configured to allow movement of the third rolling members along the rotation axis, and restrict movement of the third rolling members around the rotation axis.

According to this aspect, the load on each rolling members can be reduced. It is possible to suppress damage to the first corresponding groove and the second corresponding groove due to the rolling of the third rolling members. Energy loss in the rolling of the third rolling members can be suppressed, and torque can be more efficiently transmitted via the third rolling members.

(16) The above aspect may be such that the first groove and the first corresponding groove each have the same number of the crest portions and the trough portions, the second groove and the second corresponding groove each have the same number of the crest portions and the trough portions, and at least one of the first rolling members is configured to be positioned on the crest portion of the first groove when at least one of the third rolling members are positioned on the trough portion of the first corresponding groove, and to be positioned on the crest portion of the second groove when at least one of the third rolling members are positioned on the trough portion of the second corresponding groove.

According to this aspect, it can be the first rolling member and the third rolling member to move in opposite directions in the rotation axis AX direction, and prevent the torque transmission mechanism from swinging in the rotation axis AX direction due to the movement of the first rolling member and the third rolling member.

(17) The above aspect may be such that the first groove and the first corresponding groove are disposed such that the crest portion of the first groove and the trough portion of the first corresponding groove oppose each other and the second groove and the second corresponding groove are disposed such that the crest portion of the second groove and the trough portion of the second corresponding groove oppose each other.

According to this aspect, the torque transmission mechanism can be prevented from swinging in the rotation axis direction with a simpler configuration.

(18) The above aspect may further include a fourth member that has a cylindrical shape and that is configured to be rotatable around the rotation axis, the fourth member having an outer peripheral surface provided with a wave shaped fifth groove extending around the rotation axis; a fifth member that has an annular shape surrounding the fourth member and that is configured to be rotatable around the rotation axis, the fifth member having an inner peripheral surface provided with a sixth groove having the wave shape and extending around the rotation axis; fourth rolling members that are disposed in the fifth groove and the sixth groove and that are configured to roll in the fifth groove and the sixth groove; a third restriction member that is disposed between the fourth member and the fifth member, that is configured to allow movement of the fourth rolling members along the rotation axis, and that is configured to restrict movement of the fourth rolling members around the rotation axis; and a coupling member configured to couple the second member and the fourth member so as to be rotatable around the rotation axis, wherein the fourth member and the fifth member are disposed side by side with the first member and the second member in the direction of the rotation axis, the fifth groove includes a fifth curved portion having a curved shape in at least a part of the fifth groove, the sixth groove includes a sixth curved portion having a curved shape in at least a part of the sixth groove, and the number of the crest portions and the number of the trough portions of the fifth groove are different from the number of the crest portions and the number of the trough portions of the sixth groove.

According to this aspect, the rotational speed can be decelerated in a stepwise manner between the first member and the second member and between the fourth member and the fifth member, and a higher deceleration ratio can be realized while the torque transmission mechanism is configured to be more space-saving in the radial direction. The fifth groove has the fifth curved portion and the sixth groove has the sixth curved portion, thereby the fourth rolling member can be more smoothly rolled in the fifth groove and the sixth groove. As a result, it is possible to suppress damage to the fifth groove and the sixth groove due to the rolling of the fourth rolling member. Energy loss in the rolling of the fourth rolling member can be suppressed, and torque can be more efficiently transmitted via the fourth rolling member.

(19) The above aspect may be such that the curved shape of the first curved portion and the curved shape of the second curved portion are a first type of curved shape and the curved shape of the fifth curved portion and the curved shape of the sixth curved portion are a third type of curved shape different from the first type of curved shape.

According to this aspect, the types of the curved shapes of the first curved portion and the second curved portion are different from the types of the curved shapes of the fifth curved portion and the sixth curved portion, thereby a more highly functional torque transmission mechanism can be realized. For example, when the torque transmission mechanism is used as a deceleration device that decelerates the speed of rotation of the first member and outputs the rotation from the fifth member, a type of curved shape desirable for a higher speed and a lower torque can be applied as the curved shape of the first curved portion and the second curved portion, and a type of curved shape desirable for a lower speed and a higher torque can be applied as the curved shape of the fifth curved portion and the sixth curved portion.

(20) The above aspect may be such that the first groove and the fifth groove each have the same number of the crest portions and the trough portions, the second groove and the sixth groove each have the same number of the crest portions and the trough portions, and at least one of the first rolling members is configured to be positioned on the crest portion of the first groove when at least one of the fourth rolling members are positioned on the trough portion of the fifth groove, and is configured to be positioned on the crest portion of the second groove when at least one of the fourth rolling members are positioned on the trough portion of the sixth groove.

According to this aspect, it can be the first rolling member and the fourth rolling member to move in opposite directions in the rotation axis AX direction, and prevent the torque transmission mechanism from swinging in the rotation axis AX direction due to the movement of the first rolling member and the fourth rolling member.

What is claimed is:

1. A torque transmission mechanism, comprising:
a first member that has a cylindrical shape and that is configured to be rotatable around a rotation axis, the first member having an outer peripheral surface provided with a first groove extending around the rotation axis;
a second member that has an annular shape surrounding the first member and that is configured to be rotatable around the rotation axis, the second member having an inner peripheral surface provided with a second groove extending around the rotation axis;
one or more first rolling members that are disposed in the first groove and the second groove and that are configured to roll in the first groove and the second groove; and
a first restriction member that is disposed between the first member and the second member, that is configured to allow movement of the first rolling members along the rotation axis, and that is configured to restrict movement of the first rolling members around the rotation axis, wherein
the first groove and the second groove are formed in a periodic wave shape having one or more crest portions and trough portions around the rotation axis,
the first groove includes a first curved portion having a curved shape in at least a part of the first groove, and
the second groove includes a second curved portion having a curved shape in at least a part of the second groove.

2. The torque transmission mechanism according to claim 1, wherein
the first curved portion includes at least one of the crest portion and the trough portion of the first groove.

3. The torque transmission mechanism according to claim 1, wherein
the second curved portion includes at least one of the crest portion and the trough portion of the second groove.

4. The torque transmission mechanism according to claim 1, wherein
the first curved portion includes at least one of the crest portion and the trough portion of the first groove,
the second curved portion includes at least one of the crest portion and the trough portion of the second groove, and
the curved shape of the first curved portion and the curved shape of the second curved portion include at least one of a shape according to a sine curve and an arc shape.

5. The torque transmission mechanism according to claim 4, wherein
the entire first groove and the entire second groove have a shape representing the sine curve.

6. The torque transmission mechanism according to claim 1, wherein
the entire first groove and the entire second groove have a shape representing a modified constant velocity curve.

7. The torque transmission mechanism according to claim 1, wherein
the first groove and the second groove have a shape obtained by combining two or more of a sine curve, a modified constant velocity curve, a cycloid curve, a modified trapezoid curve, a one-dwell modified trapezoid curve, a modified sine curve, and a one-dwell modified sine curve.

8. The torque transmission mechanism according to claim 1, wherein
the number of the crest portions and the number of the trough portions of the first groove are different from the number of the crest portions and the number of the trough portions of the second groove.

9. The torque transmission mechanism according to claim 1, wherein
the first rolling members have a spherical shape.

10. The torque transmission mechanism according to claim 1, wherein
the first rolling members include one rolling member and an other rolling member and
the first restriction member has one restriction section configured to allow movement of the one rolling member along the rotation axis and to restrict movement of the first rolling members around the rotation axis, and an other restriction section configured to allow movement of the other rolling member along the rotation axis and to restrict movement of the other rolling member around the rotation axis.

11. The torque transmission mechanism according to claim 1, further comprising:
a first bearing section that is disposed between the first member and the first restriction member and that is configured to hold the first member rotatably with respect to the first restriction member.

12. The torque transmission mechanism according to claim 1, further comprising:
a second bearing section that is disposed between the second member and the first restriction member and that is configured to hold the second member rotatably with respect to the first restriction member.

13. The torque transmission mechanism according to claim 8, wherein
a third groove extending around the rotation axis is provided on an outer peripheral surface of the second member,
the torque transmission mechanism further includes
a third member that has an annular shape surrounding the second member and that is configured to be rotatable around the rotation axis, the third member having an inner peripheral surface provided with a fourth groove extending around the rotation axis,
one or more second rolling members that are disposed in the third groove and the fourth groove and that are configured to roll in the third groove and the fourth groove, and
a second restriction member that is disposed between the second member and the third member, that is configured to allow movement of the second rolling members along the rotation axis, and that is configured to restrict movement of the second rolling members around the rotation axis,
the third groove and the fourth groove are formed in the wave shape having one or more of the crest portions and the trough portions around the rotation axis,
the third groove includes a third curved portion having a curved shape in at least a part of the third groove,
the fourth groove includes a fourth curved portion having a curved shape in at least a part of the fourth groove, and
the number of the crest portions and the number of the trough portions of the third groove are different from the number of the crest portions and the number of the trough portions of the fourth groove.

14. The torque transmission mechanism according to claim 13, wherein
the curved shape of the first curved portion and the curved shape of the second curved portion are each a first type of curved shape and
the curved shape of the third curved portion and the curved shape of the fourth curved portion are each a second type of curved shape different from the first type of curved shape.

15. The torque transmission mechanism according to claim 1, wherein
the first member has an outer peripheral surface provided with a first corresponding groove having the wave shape corresponding to the first groove, the first corresponding groove being disposed side by side with the first groove in the direction of the rotation axis,
the second member has an inner peripheral surface provided with a second corresponding groove having the wave shape corresponding to the second groove, the second corresponding groove being disposed side by side with the second groove in the direction of the rotation axis,
the torque transmission mechanism further includes one or more third rolling members that are disposed in the first corresponding groove and the second corresponding groove and that are configured to roll in the first corresponding groove and the second corresponding groove, and
the first restriction member is further configured to allow movement of the third rolling members along the rotation axis, and restrict movement of the third rolling members around the rotation axis.

16. The torque transmission mechanism according to claim 15, wherein
the first groove and the first corresponding groove each have the same number of the crest portions and the trough portions,
the second groove and the second corresponding groove each have the same number of the crest portions and the trough portions, and
at least one of the first rolling members is configured to be positioned on the crest portion of the first groove when at least one of the third rolling members are positioned on the trough portion of the first corresponding groove, and to be positioned on the crest portion of the second groove when at least one of the third rolling members are positioned on the trough portion of the second corresponding groove.

17. The torque transmission mechanism according to claim 16, wherein
the first groove and the first corresponding groove are disposed such that the crest portion of the first groove and the trough portion of the first corresponding groove oppose each other and
the second groove and the second corresponding groove are disposed such that the crest portion of the second groove and the trough portion of the second corresponding groove oppose each other.

18. The torque transmission mechanism according to claim 8, further comprising:
a fourth member that has a cylindrical shape and that is configured to be rotatable around the rotation axis, the fourth member having an outer peripheral surface provided with a wave shaped fifth groove extending around the rotation axis;
a fifth member that has an annular shape surrounding the fourth member and that is configured to be rotatable around the rotation axis, the fifth member having an inner peripheral surface provided with a sixth groove having the wave shape and extending around the rotation axis;
fourth rolling members that are disposed in the fifth groove and the sixth groove and that are configured to roll in the fifth groove and the sixth groove;
a third restriction member that is disposed between the fourth member and the fifth member, that is configured to allow movement of the fourth rolling members along the rotation axis, and that is configured to restrict movement of the fourth rolling members around the rotation axis; and
a coupling member configured to couple the second member and the fourth member so as to be rotatable around the rotation axis, wherein
the fourth member and the fifth member are disposed side by side with the first member and the second member in the direction of the rotation axis,
the fifth groove includes a fifth curved portion having a curved shape in at least a part of the fifth groove,
the sixth groove includes a sixth curved portion having a curved shape in at least a part of the sixth groove, and
the number of the crest portions and the number of the trough portions of the fifth groove are different from the number of the crest portions and the number of the trough portions of the sixth groove.

19. The torque transmission mechanism according to claim 18, wherein
the curved shape of the first curved portion and the curved shape of the second curved portion are a first type of curved shape and
the curved shape of the fifth curved portion and the curved shape of the sixth curved portion are a third type of curved shape different from the first type of curved shape.

20. The torque transmission mechanism according to claim 18, wherein
the first groove and the fifth groove each have the same number of the crest portions and the trough portions,
the second groove and the sixth groove each have the same number of the crest portions and the trough portions, and
at least one of the first rolling members is configured to be positioned on the crest portion of the first groove when at least one of the fourth rolling members are positioned on the trough portion of the fifth groove, and is configured to be positioned on the crest portion of the second groove when at least one of the fourth rolling members are positioned on the trough portion of the sixth groove.
